(19) United States
(12) Patent Application Publication
(10) Pub. No.: US 2005/0276492 A1
(43) Pub. Date: Dec. 15, 2005

(54) Method for calculating image difference, apparatus thereof, motion estimation device and image data compression device

(76) Inventor: Tsunenori Kimura, Shiojiri (JP)

Correspondence Address: HARNESS, DICKEY & PIERCE, P.L.C., P.O. BOX 828, BLOOMFIELD HILLS, MI, 48303, US

(21) Appl. No.: 11/147,495

(22) Filed: Jun. 8, 2005

(30) Foreign Application Priority Data
Jun. 9, 2004 (JP) 2004-171252

(51) Int. Cl. G06K 9/36

(52) U.S. Cl. 382/236

(57) ABSTRACT

A method is provided for calculating an image difference between a present image and a reference image that is older than the present image by each predetermined area.

### RELATED APPLICATIONS

This application claims priority to Japanese Patent Application No. 2004-171252 filed Jun. 9, 2004 which is hereby expressly incorporated by reference herein in its entirety.

### BACKGROUND

1. Technical Field

The present invention relates to a method for calculating an image difference, apparatus thereof, a motion estimation device and an image data compression device.

2. Related Art

Moving Picture Experts Group Phase (MPEG) is specified in order to standardize an encoding method for voice and motion-image. Among various MPEG specifications, MPEG-4 is a specification with which an image communication with a high data compression ratio is possible for mobile devices and an image quality will be maintained even with a lower bit rate.

In the MPEG-4, motion estimation is accurately performed between an inputted current image and an old image that is inputted after the current image (a reference image) and the high data compression ratio is realized while the image quality is maintained. Here, the motion estimation calculates a position where the difference between the current image and the reference image in each macro-block becomes a minimum with an accuracy of a position of a half picture element.

In the motion estimation, the position where the difference becomes a minimum is calculated by various searching methods while a position of the macro-block is kept moving. A pixel value for the position of the half pixel which is used in the motion estimation can be derived from a pixel value for a position of an integer picture element (full pixel) which composes the image. However, this calculating process takes a long time and its load is heavy because memory access for reading out the pixel value of the whole pixel position and operation for obtaining the pixel value for a half pixel position from the pixel value of the integer pixel position are repeatedly performed in order to search the position where the difference becomes a minimum.

The present invention has been developed in consideration of the above-mentioned problem, and intended to provide a method for calculating an image difference with which a processing load of the memory access and the operation for calculating the pixel value of the half pixel position can be reduced. The present invention is also intended to provide an apparatus thereof, a motion estimation device and an image data compression device.

### SUMMARY

In order to solve above-mentioned problems, in a first aspect of the invention, a method for calculating an image difference between a present image and a reference image that is older than the present image by each predetermined area includes a step of reading out a pixel value of a integer pixel position from a memory in a vertical direction of the reference image while sequentially reading out the pixel value in order of the integer pixel position that aligns in a horizontal direction of the reference image starting from a first integer pixel position placed in an outer side of the predetermined area in the reference image, a step of calculating pixel values of a plurality of half pixel positions, which are specified by the integer pixel position and a second integer pixel position that is adjacent to the integer pixel position and read out before the integer pixel position, based on the pixel value of the integer pixel position and a pixel value of the second integer pixel position every time the pixel value of the integer pixel position in the predetermined area is read out and a step of calculating a difference between a pixel value of a half pixel position out of the plurality of the half pixel positions in the reference image and a pixel value of a third integer pixel position corresponding to the half pixel position in the present image.

In the method, the pixel values of the plurality of the half pixel positions, which are specified by the integer pixel position, a fourth integer pixel position adjacent to the integer pixel position in the horizontal direction, a fifth integer pixel position adjacent to the integer pixel position in the vertical direction and a sixth integer pixel position adjacent to the fourth integer pixel position in the vertical direction and adjacent to the fifth integer pixel position in the horizontal direction, may be calculated based on the pixel value of the integer pixel position and pixel values of the fourth through sixth integer pixel positions every time the pixel value of the integer pixel position in the predetermined area is read out.

According to the first aspect of the invention, the pixel value of the integer pixel position is read out in a predetermined order from the memory in which the pixel value of the reference image is stored. In other words, the pixel value of the integer pixel position is read out in order of the integer pixel position that aligns in the horizontal direction of the reference image starting from the first integer pixel position placed in an outer side of the predetermined area set in the reference image. When a line's worth of integer pixel position is read out in the horizontal direction of the reference image, pixel values of the integer pixel positions which are in the next line adjacent to the first pixel position in the vertical direction of the reference image are read out in the above-mentioned order. The pixel values read out from the memory in this way are temporary stored in, for example, buffer and the like.

The pixel values of the plurality of the half pixel positions, which are specified by the integer pixel position and the second integer pixel position that is adjacent to the integer pixel position and read out before the integer pixel position, are then calculated every time the pixel value of the integer pixel position in the predetermined area is read out. These pixel values are calculated based on the pixel value of the integer pixel position and the pixel value of the second integer pixel position. Subsequently, the difference between the pixel value of the half pixel position out of the plurality of the half pixel positions obtained by the above described way and the pixel value of the third integer pixel position corresponding to the half pixel position in the present image is calculated.

In the first aspect of the invention, focusing attention on the fact that the half pixel position around each integer pixel position, for example, each of the eight half pixel positions is shared by two or four integer pixel positions, the pixel value of the half pixel position can be calculated by using the pixel value of not only a horizontally adjacent integer pixel position but also a vertically adjacent integer pixel position. Therefore, the operation of the half pixel position will not be redundantly performed and unnecessary memory access will be reduced. As a result, a processing load of the operation for calculating the image difference with half pixel accuracy can be reduced and a processing time can also be shorten.

In the method, differences of the plurality of the half pixel positions that are placed around the integer pixel position may be calculated every time the pixel value of the integer pixel position in the predetermined area is read out.

When the error calculation between the half pixel position and the corresponding integer pixel position is possible, the error calculation is performed every time the pixel value of the half pixel position is calculated. Consequently, in addition to the above-mentioned advantages, the process of the image difference calculation with the half pixel accuracy can be speeded up.

Furthermore, in the method, the predetermined area may be a block that is obtained by dividing a macro-block in quarters and has 8 pixels respectively aligning in both the vertical direction and the horizontal direction, the macro-block has 16 pixels respectively aligning in both the vertical direction and the horizontal direction, and the difference between the present image and the reference image may be calculated by the block and the difference is calculated by the macro-block by using the difference obtained by the block.

Moreover, in the method, if two blocks aligning in the horizontal direction out of four blocks obtained by dividing the macro-block in quarters are respectively a first block and a second block, it is preferred that a pixel value of a first half pixel position that is shared by the first block and the second block is calculated in only one of the first block and the second block.

Moreover, in the method, if two blocks aligning in the vertical direction out of the four blocks obtained by dividing the macro-block in quarters are respectively the first block and a third block, it is preferred that a pixel value of a second half pixel position that is shared by the first block and the third block is calculated in only one of the first block and the third block.

According to the first aspect of the invention, the processing time for calculating the image difference can be shorten because the overlapping operation for the pixel value of half pixel position can be omitted.

An image difference operation device of a second aspect of the invention for calculating a difference between a present image and a reference image that is older than the present image by each predetermined area includes a half pixel position operation part calculating a pixel value of a half pixel position in the reference image by using a pixel value of an integer pixel position in the reference image read out from a memory and a difference operation part calculating a difference between the pixel value of the half pixel position obtained by the half pixel position operation part and a pixel value of a integer pixel position corresponding to the half pixel position in the present image. The half pixel position operation part reads out the pixel value of the integer pixel position from the memory in a vertical direction of the reference image while the half pixel position operation part sequentially reads out the pixel value in order of the integer pixel position that aligns in a horizontal direction of the reference image starting from a first integer pixel position placed in an outer side of the predetermined area in the reference image. And the half pixel position operation part calculates pixel values of a plurality of half pixel positions, which are specified by the integer pixel position and a second integer pixel position that is adjacent to the integer pixel position and read out before the integer pixel position, based on the pixel value of the integer pixel position and a pixel value of the second integer pixel position every time the pixel value of the integer pixel position in the predetermined area is read out.

In the image difference operation device, the half pixel position operation part may calculate the pixel values of the plurality of the half pixel positions, which are specified by the integer pixel position, a fourth integer pixel position adjacent to the integer pixel position in the horizontal direction, a fifth integer pixel position adjacent to the integer pixel position in the vertical direction and a sixth integer pixel position adjacent to the fourth integer pixel position in the vertical direction and adjacent to the fifth integer pixel position in the horizontal direction, based on the pixel value of the integer pixel position and pixel values of the fourth through sixth integer pixel positions every time the pixel value of the integer pixel position in the predetermined area is read out.

Furthermore, in the image difference operation device, the half pixel position operation part may calculate differences of the plurality of the half pixel positions that are placed around the integer pixel position every time the pixel value of the integer pixel position in the predetermined area is read out.

According to the second aspect of the invention, it is possible to provide the image difference operation device with which the processing load of the operation for calculating the image difference with half pixel accuracy can be reduced and the processing time can also be shorten. In addition, it is also possible to provide the image difference operation device with which the process of the image difference calculation with the half pixel accuracy can be speeded up in addition to the above-mentioned advantages because the error calculation is performed every time the pixel value of the half pixel position is calculated if the error calculation between the half pixel position and the corresponding integer pixel position is possible.

A motion estimation device of a third aspect of the invention includes the above mentioned image difference operation device and a motion vector generation part generating a motion vector between the present image and the reference image whose difference is calculated by the image difference operation device, and generating the motion vector at which the difference or a difference by the macro-block obtained by using the difference becomes a minimum.

According to the third aspect of the invention, it is possible to provide the motion estimation device with which the processing load of the operation for calculating the image difference with half pixel accuracy can be reduced and the processing time can also be shorten. In addition, it is also possible to provide the motion estimation device with which the process of the image difference calculation with the half pixel accuracy can be speeded up in addition to the above-mentioned advantages because the error calculation is performed every time the pixel value of the half pixel position is calculated if the error calculation between the half pixel position and the corresponding integer pixel position is possible. Consequently, it is possible to perform the motion estimation which could be a problem in the series of the encoding processes at a higher speed.

An image data compression device of a fourth aspect of the invention includes the above-mentioned image difference operation device and a quantization part quantizing a difference generated by the image difference operation device.

According to the fourth aspect of the invention, it is also possible to provide the image data compression device with which the process of the image difference calculation with the half pixel accuracy can be speeded up.

### BRIEF DESCRIPTION OF THE DRAWINGS

FIG. 1 shows a configuration of an image data compression system to which a motion estimation device of this embodiment is applied.

FIG. 2 is an explanatory drawing of a macro-block and a block.

FIG. 3 is an explanatory drawing of an example of DTC coefficient.

FIG. 4 is an explanatory drawing of an example of a quantization table.

FIG. 5 is an explanatory drawing of an example of a quantized DCT coefficient.

FIG. 6 shows a decoding process of a compressed image data by an encoding process of the image data compression system shown in FIG. 1.

FIG. 7 shows an idea of a motion estimation process.

FIG. 8 is a flow diagram of an example of the motion estimation process in the embodiment.

FIG. 9 is an explanatory drawing for an integer pixel position and a half pixel position.

FIG. 10 is a flow diagram of a process example for calculating a minimum error position with integer pixel accuracy in the embodiment.

FIG. 11 is an explanatory drawing for a range of a logarithmic search in a reference image.

FIG. 12 shows a flow of a process example of an error calculation with the integer pixel accuracy.

FIG. 13 is a flow diagram of a process example for calculating the minimum error position with half pixel accuracy in the embodiment.

FIG. 14 is an anterior half flow of the process example for calculating the error with the half pixel accuracy in a comparative example.

FIG. 15 is a posterior half flow of the process example for calculating the error with the half pixel accuracy in the comparative example.

FIG. 16 shows a relation between the macro-block and the block in the embodiment.

FIG. 17 is a view showing a frame format of the integer pixel position and the half pixel position in a block BL0 shown in FIG. 16.

FIG. 18 is a view showing a frame format of the integer pixel position and the half pixel position in a block BL1 shown in FIG. 16.

FIG. 19 is an explanatory drawing for a calculation of the half pixel position in the embodiment.

FIG. 20 is an explanatory drawing of the error calculation in the embodiment.

FIG. 21 is an anterior half flow of a process example for calculating the error with the half pixel accuracy in the embodiment.

FIG. 22 is a posterior half flow of the process example for calculating the error with the half pixel accuracy in the embodiment.

FIG. 23 is a block diagram of a hardware configuration example of a motion estimation part shown in FIG. 1.

FIG. 24 is a block diagram of a configuration example of an operational circuit for a half pixel absolute difference shown in FIG. 23.

FIG. 25 is an explanatory drawing for a movement example of an operation timing generation circuit.

FIG. 26 is an explanatory drawing for the movement example of the operation timing generation circuit.

FIG. 27 is a timing chart of an operation example of the motion estimation part shown in FIG. 24.

### DETAILED DESCRIPTION

Embodiments of the present invention will now be described in detail with reference to the accompanying drawings. Note that the embodiments described hereunder do not in any way limit the scope of the invention defined by the claims laid out herein. Note also that all of the elements of these embodiments should not be taken as essential requirements to the means of the present invention.

1. MPEG-4

Firstly, an image data compression system to which a motion estimation device according to the present embodiment is applied will be described.

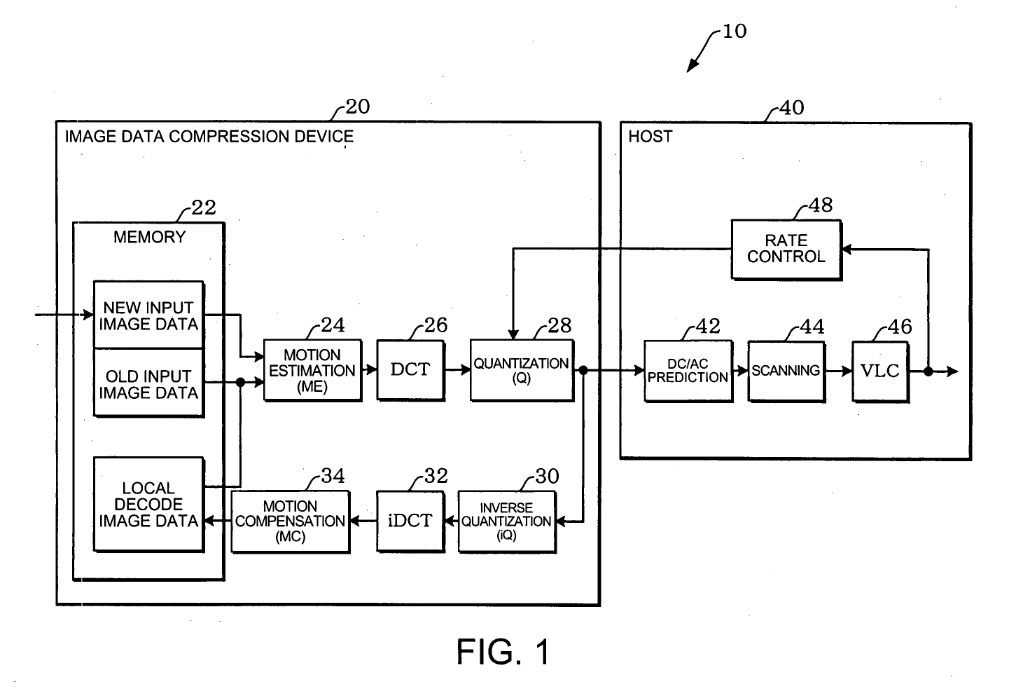

FIG. 1 shows a configuration of the image data compression system. This image data compression system 10 includes an image data compression device 20 and a host 40. The image data compression system 10 performs an encoding process of the MPEG-4. Functions of the image data compression device 20 are realized by hardware. The host 40 has an unshown central processing unit (CPU) and a memory. The CPU reads out a program stored in the memory and performs a process according to the program and then a function of the host 40 can be exerted.

The image data compression device 20 includes a memory 22. For example, one frame's worth of an image data of a motion image inputted from a camera module (an imaging unit) is stored in the memory 22 as a new input image data. An old input image data which is older than the frame of the new input image data is also stored in the memory 22. Furthermore, a local decode image data is also stored in the memory 22.

The image data compression device 20 includes a motion estimation part 24 (the motion estimation device in a broad sense), a discrete cosine transformation (DCT) part 26, a quantization part 28, an inverse quantization part 30, an inverse DCT part 32 and a motion compensation part 34.

The motion estimation part 24 conducts motion estimation between two different images (two frames) in terms of time. More specifically, a difference of the two images in the same full pixel (a difference with an integer pixel accuracy) or a difference between a pixel in one image and a corresponding half pixel in the other image (a difference with the half pixel accuracy) is calculated by a macro-block. A motion vector between the two images at which the calculated difference becomes a minimum is then outputted. In this case, after the difference between the two images is calculated with the integer pixel accuracy and a position where the difference becomes a minimum is calculated, the difference between the two images is calculated with the half pixel accuracy and a position where the difference accurately becomes a minimum is further identified. The difference in an unchanged image area between the two images becomes zero and an information volume can be lessened. In addition to this zero data in the image area, a difference (plus and minus component) in a changed image area between the two images is also the information after the motion estimation. The macro-block (MB) is a unit area which is 16 pixels×16 pixels. In other words, 16 picture elements are aligned both vertically and horizontally in this macro-block area.

The motion estimation part 24 of this embodiment calculates a difference between the new input image data and one of the old input image data or the local decode image data. Decision to output either the old input image data or the local decode image data depends on a convergence speed of the motion estimation. For example, the old input image data is outputted when the difference is calculated with the integer pixel accuracy in order to increase the convergence speed of the motion estimation. When the difference is calculated with the half pixel accuracy, the local decode image data is outputted.

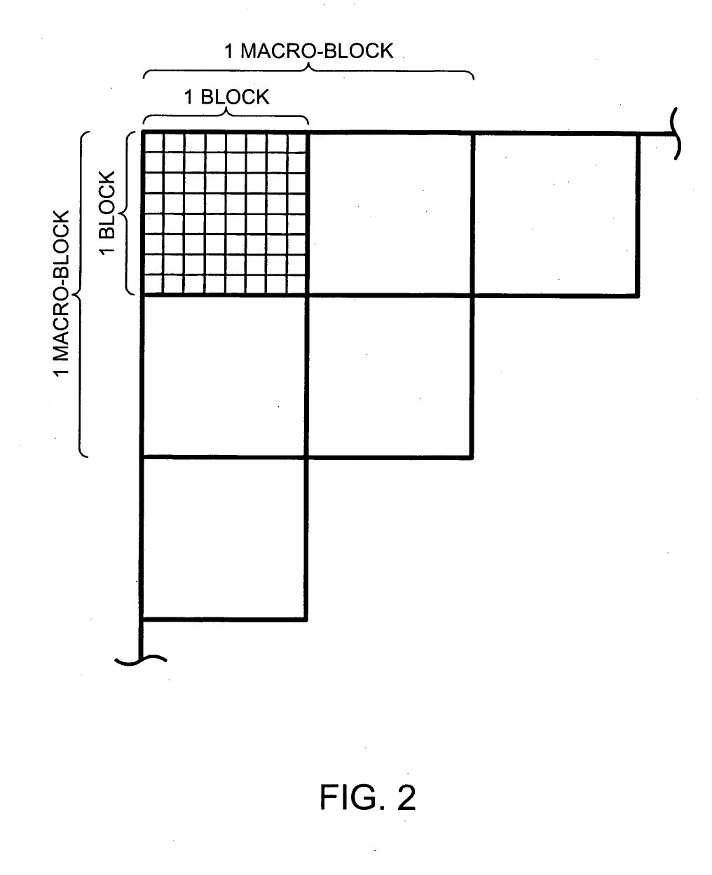

The DCT part 26 calculates a DCT coefficient by macro-blocks and performs the calculation in each macro-block which is 8 pixels×8 pixels as shown in FIG. 2. One block is an area obtained by dividing the macro-block in quarters. In other words, 8 picture elements are aligned both vertically and horizontally in the block. Details of the DCT are described in, for example, a book “JPEG&MPEG, illustrated image compression technology” written by Hiroshi Ochi and Hideo Kuroda (Publisher: Nippon Jitsugyo Publishing Co., Ltd.).

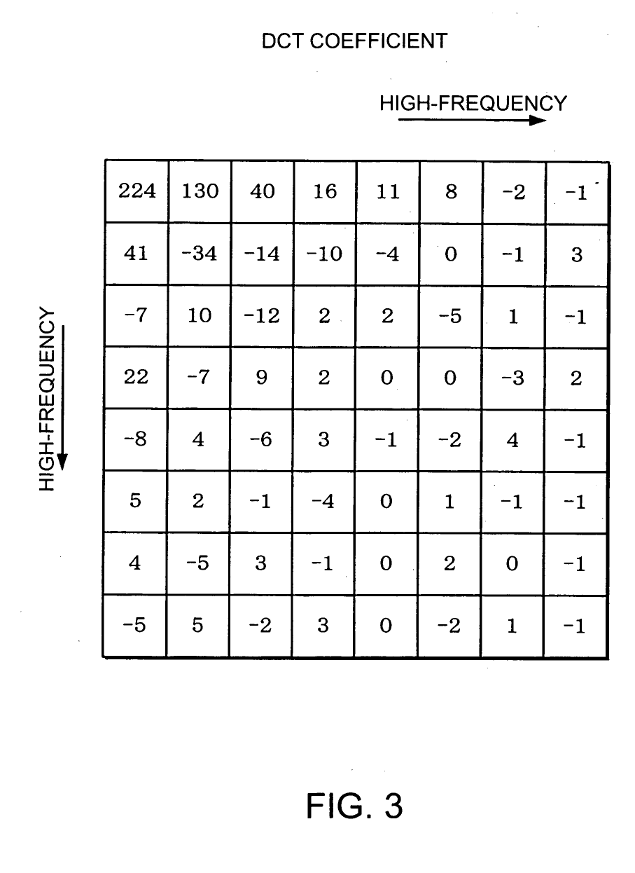

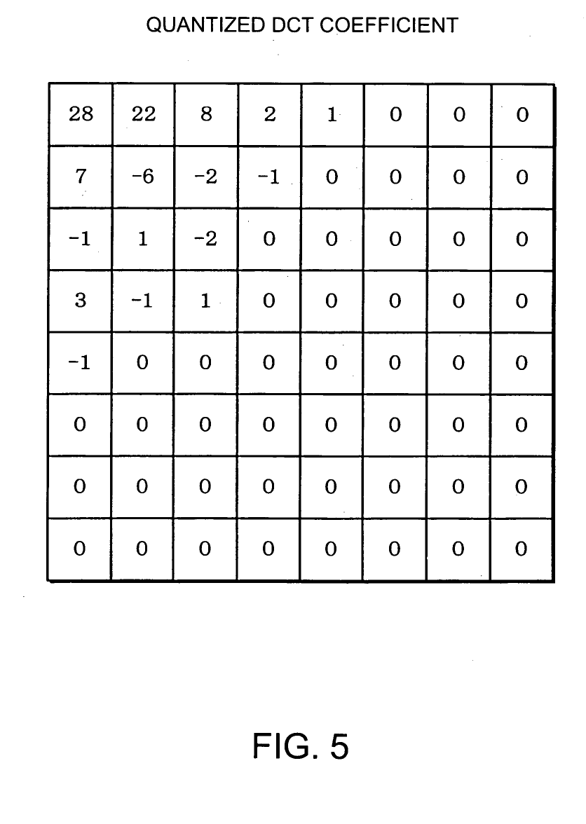

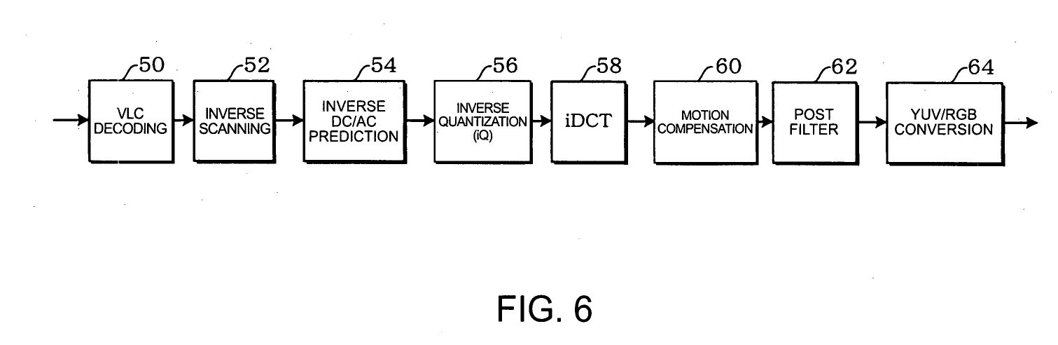

The DTC coefficient after the discrete cosine transformation expresses a gray scale change in the block by brightness of the whole block (DC component) and a spatial frequency (AC component). FIG. 3 shows an example of the DTC coefficient in the block of 8 pixels×8 pixels (quotation from FIG. 5-6, page 116 of the above-mentioned book). The figure of the DTC coefficient on the upper-left corner is the DC component and the rest of the figures of the DTC coefficient are the AC components. Even when the high-frequency components in the AC components are omitted, it has a small impact on image recognition.

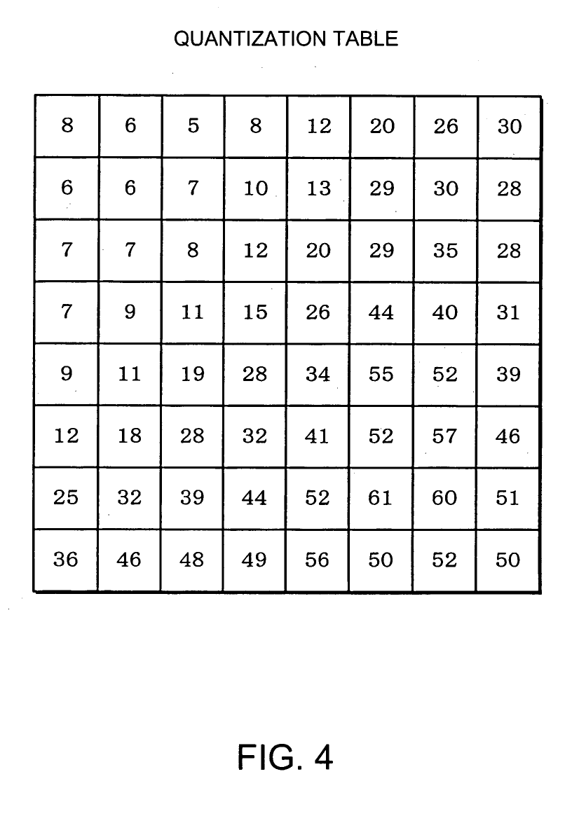

In the quantization part 28, each DCT coefficient in the block is divided by the corresponding quantization step value in a quantization table in order to decrease the information volume. As an illustration, the DCT coefficient shown in FIG. 3 is quantized by using the quantization table shown in FIG. 4 and the result of the quantized DCT coefficient is shown in FIG. 5 (quotation from FIG. 5-9 and FIG. 5-10, page 117 of the above-mentioned book). As shown in FIG. 5, when the DCT coefficients of the high-frequency components are divided by the quantization step value and the result is rounded off to the nearest whole number, most of the elements of the coefficients become zero data and the information volume is significantly decreased. Therefore, in other words, the quantization part 28 quantizes the above-mentioned difference between the two images.

In the image data compression device 20, in order to conduct the above-mentioned motion estimation (ME), a feedback route is required. In this feedback route, an inverse quantization (iQ), an inverse DCT and motion compensation (MC) are performed as shown in FIG. 1A. The local decode image data is generated by conducting a decoding process which corresponds to an encoding process including the motion estimation, the DCT and the quantization. The local decode image data is stored in the memory 22. Though detailed operation of the motion compensation will be omitted here, this process is carried out by the macro-block which is 16 pixels×16 pixels as shown in FIG. 2.

In the host 40, the CPU realizes functions of a DC/AC (direct current/alternate current component) prediction part 42, a scanning part 44, a variable length code (VLC) part 46 and a rate control part 48.

Both a DC/AC prediction process performed in the DC/AC prediction part 42 and a scan process conducted in the scanning part 44 are necessary in order to enhance the efficiency of conversion into a variable length code conducted in the VLC part 46. This is because the difference of the DC components between the two consecutive blocks is encoded in order to code into the VLC. As for the AC components, order of the coding has to be decided by scanning the block (also called as zigzag scan) from a lower frequency to a higher frequency.

The conversion into the variable length code is also called as an entropy coding. According to the entropy coding, fewer codes are given to a component which appears more frequently. Here, Huffman coding is adopted as the entropy coding.

Then, the VLC part 46 encodes the difference of the DC components between the two consecutive blocks by using the results of the DC/AC prediction part 42 and the scanning part 44. As for the AC components, the DCT coefficient value is encoded in the above-mentioned scan order from the lower frequency to the higher frequency by using the results of the DC/AC prediction part 42 and the scanning part 44.

Information production of the image data fluctuates according to intricateness of the image or intensity of the image motion. In order to absorb the fluctuation and transmit the data at a constant transmission rate, code generation has to be controlled. That is a rate control performed in rate control part 48. Generally, a buffer memory is provided for the rate control. An information volume accumulated in the buffer memory is monitored in order to prevent the buffer memory from overflowing. In this way, the information production is controlled. To be more specific, bit number which indicates the DCT coefficient value is reduced by making a quantizing property in the quantization part 28 coarse.

FIG. 6 shows a decoding process of the compressed image data by the encoding process of the image data compression system 10 shown in FIG. 1. This decoding process is carried out by performing inverse processes of the coding process of the image data compression system 10 shown in FIG. 1 in a reverse order. A “post filter” in FIG. 6 is a filter to eliminate the block-noise. “YUV/RGB conversion” shown in FIG. 6 means that output of the post filter is converted from a YUV format to a RGB format.

2. Motion Estimation

As described above, the accuracy of the motion estimation largely affects the image quality because the result of the motion estimation is encoded. It is also important to have a large throughput of the motion estimation and realize the motion estimation with a high speed and high accuracy. An image difference calculation in this embodiment is conducted in a motion estimation process performed in the motion estimation part 24 shown in FIG. 1.

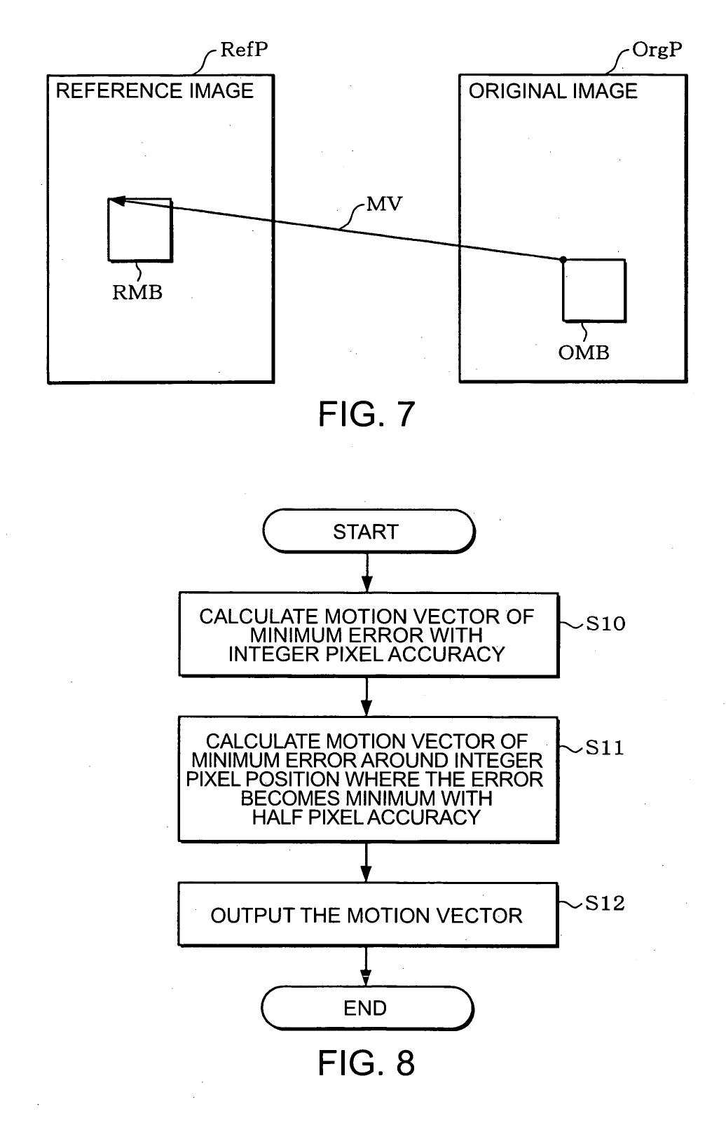

FIG. 7 schematically shows an idea of the motion estimation process.

In the motion estimation process, a motion vector MV is estimated. Here, the image of the old input image data or the image of the local decode image data shown in FIG. 1 is referred as a reference image RefP and the image of the new input image data (present image) is referred as an original image OrgP. In the motion estimation process, a position where a difference between a reference macro-block RMB and an original macro-block OMB becomes a minimum is calculated. Here, the reference macro-block RMB is the macro-block set in the reference image RefP and the original macro-block OMB is the macro-block set in the original image OrgP. Then, the motion vector MV at which the difference between these macro-blocks becomes a minimum is outputted.

FIG. 8 is a flow diagram of an example of the motion estimation process in the embodiment.

Firstly, a motion vector at which the difference between the macro-blocks becomes a minimum is calculated with the integer pixel accuracy (Step 10 or S10). The difference is obtained as a summation of errors of the pixel values of the pixels that are compared in the both of the macro-blocks. Here, the motion vector is calculated at a minimum error position where this summation of errors becomes smallest based on a predetermined position (for example, a pixel at the upper left) of the reference macro-block RMB and a predetermined position of the original macro-block OMB which corresponds to the predetermined position of the reference macro-block RMB.

Subsequently, a finer motion vector at which the error between the macro-blocks becomes a minimum is calculated (Step 11 or S11). This finer motion vector is calculated by a half pixel position around an integer pixel position of the minimum error position obtained in Step 10.

Then, the motion vector obtained in Step 11 is outputted as a final motion vector MV (Step 12 or S12).

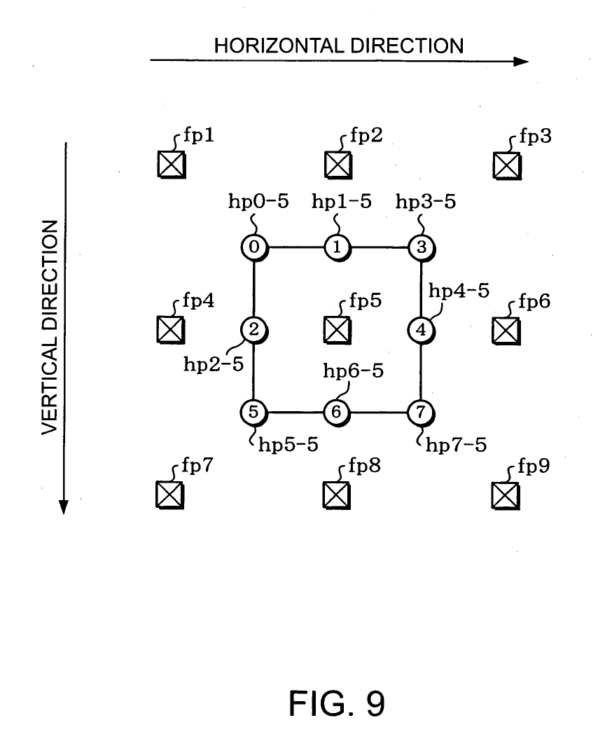

FIG. 9 is an explanatory drawing for the integer pixel position and the half pixel position.

FIG. 9 shows a part of the macro-block. The integer pixel position is a position of a pixel which forms an image. In FIG. 9, integer pixel positions fp1-fp9 are shown. A pixel value of each integer pixel position is a luminance data.

The half pixel position is derived from two or four adjacent integer pixel positions. In FIG. 9, eight half pixel positions hp0-5 through hp7-5 around the integer pixel position fp5 are shown. The pixel value of the half pixel position hp0-5 is obtained as an average of the pixel values of the four integer pixel positions fp1, fp2, fp4 and fp5. The pixel value of the half pixel position hp1-5 is obtained as an average of the pixel values of the two integer pixel positions fp2 and fp5. The pixel value of the half pixel position hp2-5 is calculated by taking an average of the pixel values of the two integer pixel positions fp4 and fp5. The pixel value of the half pixel position hp3-5 is calculated by taking an average of the pixel values of the four integer pixel positions fp2, fp3, fp5 and fp6. The pixel value of the half pixel position hp4-5 is obtained as an average of the pixel values of the two integer pixel positions fp5 and fp6. The pixel value of the half pixel position hp5-5 is obtained as an average of the pixel values of the four integer pixel positions fp4, fp5, fp7 and fp8. The pixel value of the half pixel position hp6-5 is calculated by taking an average of the pixel values of the two integer pixel positions fp5 and fp8. The pixel value of the half pixel position hp7-5 is calculated by taking an average of the pixel values of the four integer pixel positions fp5, fp6, fp8 and fp9.

For example, the average of the half pixel position, in case that it can be obtained as the average of the pixel values of the four integer pixel positions, is obtained from the following equation.
R=(A+B+C+D+2−r)/4 (1)

Here, R is the pixel value of the half pixel position, A-D are the pixel values of the four integer pixel positions and r is a control variable for controlling the numbers after the decimal point to be rounded up or cut down.

The average of the half pixel position, in case that it can be obtained as the average of the pixel values of the two integer pixel positions, for example, is obtained from the following equation.
R=(A+B+1−r)/2 (2)

As described above, after the minimum error position is roughly calculated in the integer pixel unit, the minimum error position is calculated in the half pixel unit with a finer accuracy in this embodiment.

3. Calculation of Image Difference

3.1 Integer Pixel Accuracy

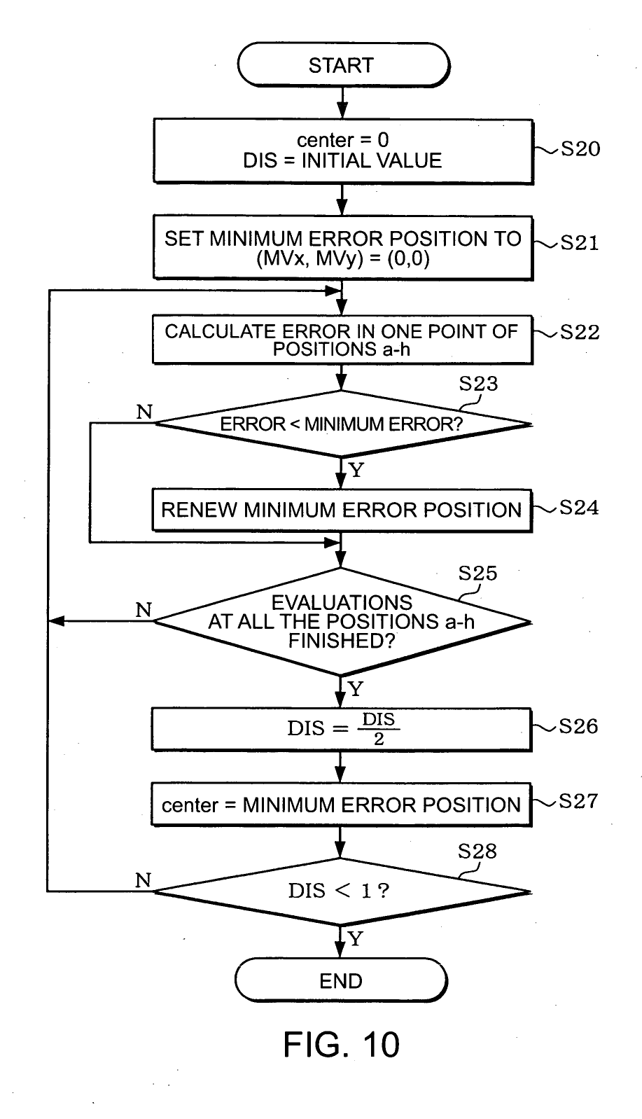

FIG. 10 is a flow diagram of a process example for calculating the minimum error position with the integer pixel accuracy in this embodiment. Here, the case that the minimum error position is calculated by a method called “logarithmic search” is described. This process is performed in Step 10 shown in FIG. 8.

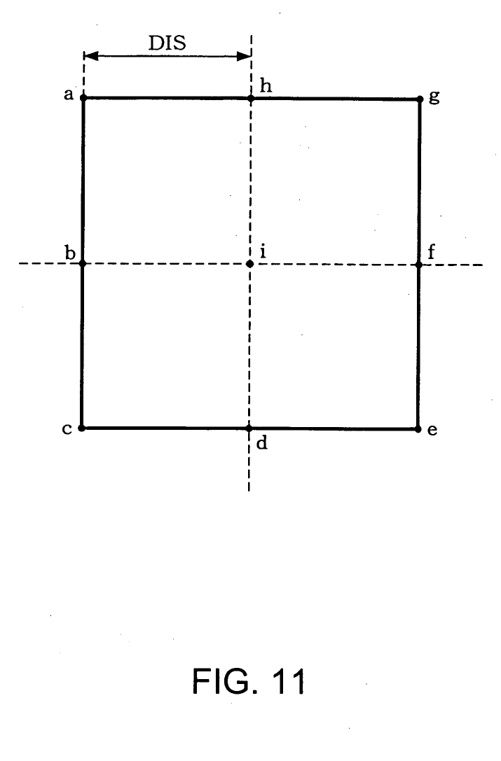

FIG. 11 is an explanatory drawing for a range of the logarithmic search in the reference image.

At an initial state, a center position “i” of the logarithmic search is placed at a position where a horizontal component MVx and a vertical component MVy of the motion vector become zero. After the position “i” is set, positions “b, f, d and h” are set in places where is horizontally and vertically separated from the position “i” by a variable DIS which specifies the search range. A position “a” depends on the positions “b and h” and a position “g” is determined by the positions “h and f”. A position “c” depends on the positions “b and d” and a position “e” is determined by the positions “d and f”.

A difference between one of the eight position “a-h” and the integer pixel position of the original image which corresponds to the center position “i” is calculated. Then, the position where the difference becomes a minimum is obtained.

More specifically, in FIG. 10, a variable “center” is set to zero and an initial value is set to the variable “DIS” (Step 20 or S20). As for the minimum error position, a position where the motion vector becomes a zero vector is set.

Next, one position from the positions “a-h” shown in FIG. 11 is selected (for example, the position “a” is selected at a first time, the position “b” is selected at a second time, . . . ) and then the error between this selected position and the integer pixel position of the original image which corresponds to the center position “i” of the logarithmic search is calculated (Step 22 or S22). This error can be calculated as, for example, the summation of the absolute differences.

Subsequently, whether the error obtained in Step 22 is smaller than a minimum error which is the error at the minimum error position or not is judged (Step 23 or S23). When the error obtained in Step 22 is considered to be smaller than the minimum error (Step 23: Y), the minimum error position is updated with the position (one of the positions “a-h”) which was selected in order to calculate the error in Step 22 (Step 24 or S24).

In Step 23, if the error obtained in Step 22 is considered to be equal or larger than the minimum error (Step 23: N), or if the evaluations of the all the positions “a-h” whether they are the minimum error positions or not are not finished yet after Step 24 (Step 25: N), return to Step 22.

In Step 25, when the evaluations of the all the positions “a-h” whether they are the minimum error positions or not are finished (Step 25: Y), a half value of the variable “DIS” is newly set to the variable “DIS” (Step 26 or S26) and the minimum error position as of Step 25 is set to the variable “center” (Step 27 or S27).

Next, when the variable “DIS” is equal to or larger than 1 (Step 28: N), return to Step 22. In Step 28, if the variable “DIS” is smaller than 1 (Step 28: Y), a series of the processes is ended (END). In other words, the minimum error position in the integer pixel unit is obtained so that a process to calculate the minimum error position in the half pixel unit will be subsequently conducted. This process will be hereinafter described in detail.

A process example of the operation for obtaining the error with the integer pixel accuracy performed in Step 22 shown in FIG. 10 will be now described.

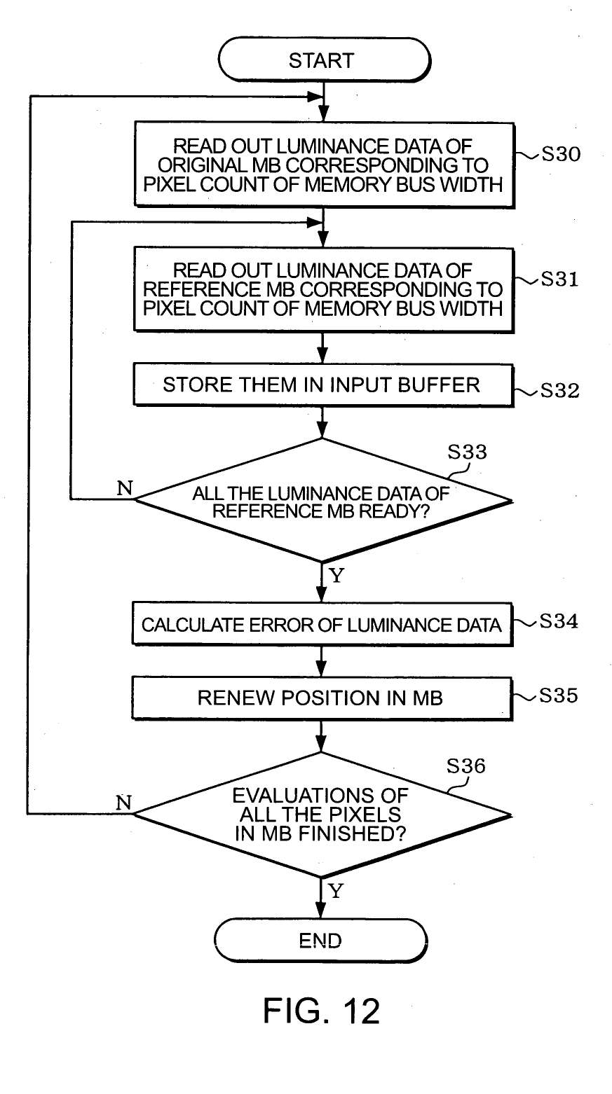

FIG. 12 shows a flow of the process example of the error operation with the integer pixel accuracy.

Here, the luminance data (pixel value) of the integer pixel positions which align in the horizontal direction of an image is previously stored on the memory 22 in order of the vertical direction of the image. The image includes images of the new input image data, the old input image data and the local decode image data. The luminance data is read out in the order of the vertical direction of the image while the luminance data is sequentially read out form the memory 22 in order of the integer pixel position which aligns in the horizontal direction in the image.

Firstly, the luminance data of the original macro-block OMB having a pixel count which corresponds to a memory bus width is read out from the memory 22 (Step 30 or S30). For example, when the memory bus width is 32 bits and the luminance data of each pixel is 8 bits, 4 pixels' worth of the luminance data is read out at each time.

In the same manner, the luminance data of the reference macro-block RMB having the pixel count which corresponds to the memory bus width is read out from the memory 22 (Step 31 or S31) and the luminance data is stored in an input buffer (Step 32 or S32). This process is repeated until the luminance data of the reference macro-block RMB gets ready (Step 33: N).

When the luminance data of the reference macro-block RMB is ready (Step 33: Y), the error between the luminance data of the original macro-block OMB read out in Step 30 and the luminance data of the reference macro-block RMB as of Step 33 is calculated (Step 34 or S34). At this time, the integer pixel position of the original macro-block OMB in which the error is calculated is related to the integer pixel position of the reference macro-block RMB. For example, four pixels' worth of the errors between the luminance data of these two macro-blocks is calculated at one time. In the error calculation in Step 34, an absolute value of the error obtained by the pixel is cumulated.

Subsequently, the position in the macro-block is renewed in order to calculate the next error (Step 35 or S35). If the evaluations of all the pixels in the macro-block are not finished yet (Step 36: N), return to Step 30. If the evaluations of all the pixels in the macro-block are finished (Step 36: Y), a series of the processes is ended (END).

3.2 Half Pixel Accuracy

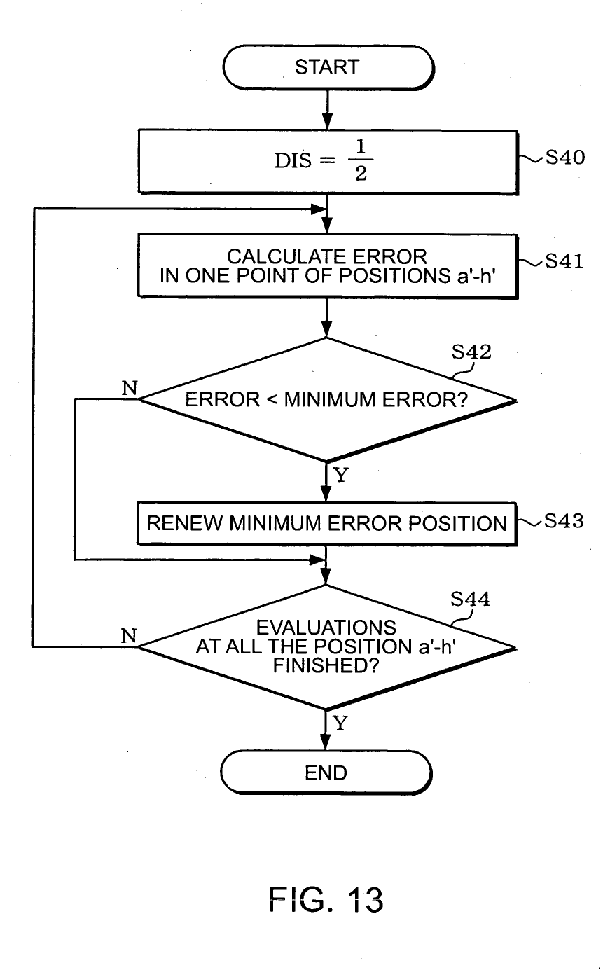

FIG. 13 is a flow diagram of a process example for calculating the minimum error position with the half pixel accuracy in this embodiment. This process is performed in Step 11 shown in FIG. 8.

Firstly, ½ is set to the variable “DIS” (Step 40 or S40). Corresponding to this variable “DIS”, positions “a′-h′” are set in the same way as FIG. 11.

One position from the positions “a′-h′” is selected (for example, the position “a′” is selected at a first time, the position “b′” is selected at a second time, . . . ) and then the error between this selected position and the integer pixel position of the original image which corresponds to the center position “i” of the logarithmic search is calculated (Step 41 or S41). This error can be calculated as, for example, the summation of the absolute differences.

Subsequently, whether the error obtained in Step 41 is smaller than a minimum error which is the error at the minimum error position or not is judged (Step 42 or S42). When the error obtained in Step 41 is considered to be smaller than the minimum error (Step 42: Y), the minimum error position is updated with the position (one of the positions “a′-h′”) which was selected in order to calculate the error in Step 41 (Step 43 or S43).

In Step 42, if the error obtained in Step 41 is considered to be equal or larger than the minimum error (Step 42: N), or if the evaluations of the all the positions “a′-h′” whether they are the minimum error positions or not are not finished yet after Step 43 (Step 44: N), return to Step 41.

In Step 44, when the evaluations of the all the positions “a′-h′” whether they are the minimum error positions or not are finished (Step 44: Y), a series of the processes is ended (END).

A process example of the operation for obtaining the error with the half pixel accuracy performed in Step 41 shown in FIG. 13 will be now described. Before describing the error operation with the half pixel accuracy in this embodiment, a process example of the error operation with the half pixel accuracy in a comparative example will be described.

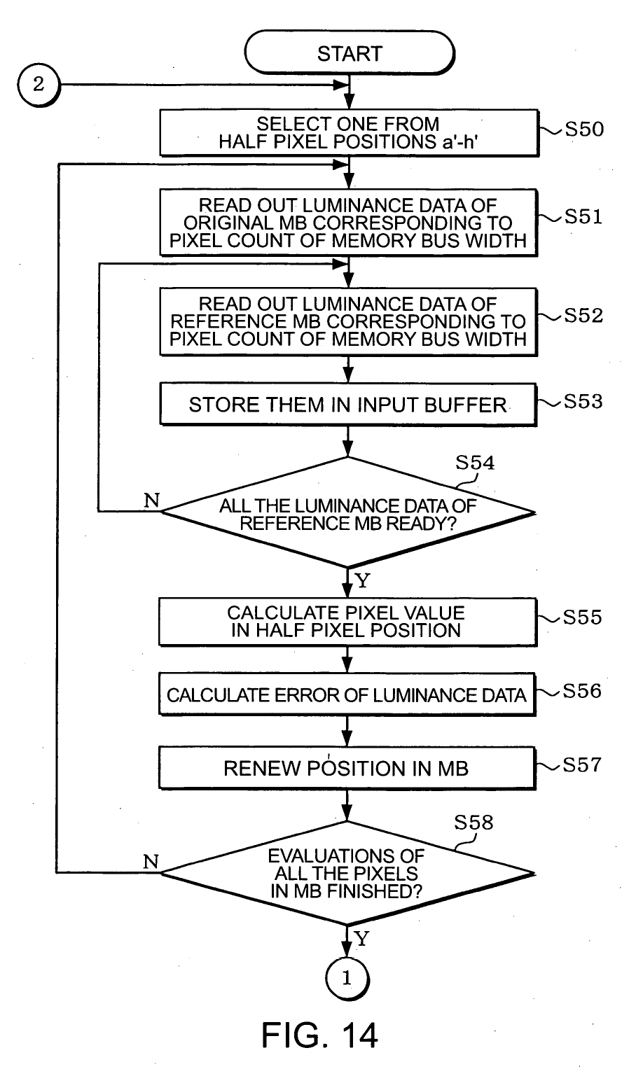

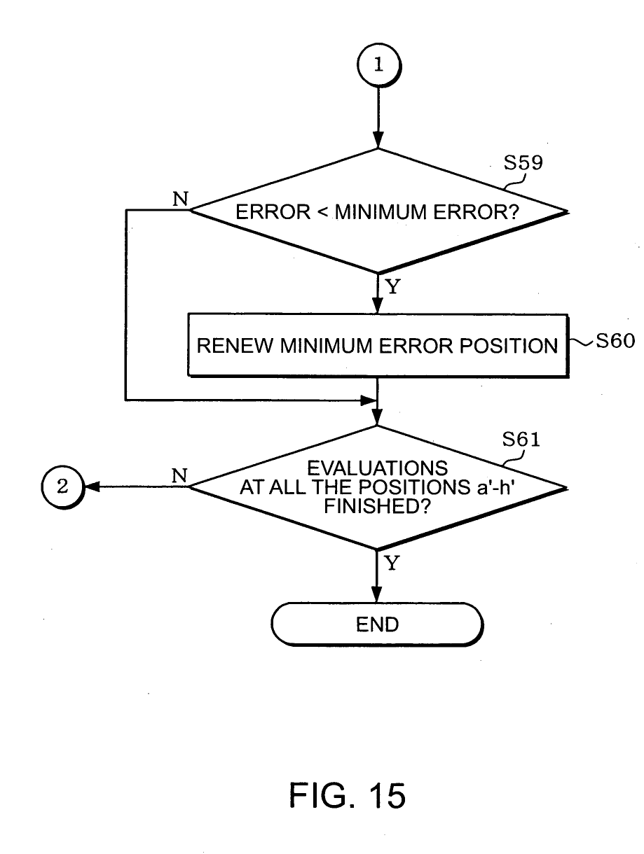

FIG. 14 and FIG. 15 is a flow of the process example of the error operation with the half pixel accuracy in the comparative example.

The positions “a′-h′” are set correlating to the variable “DIS” at the time of Step 41 in FIG. 13. Then, one is selected from the positions “a′-h′” (Step 50 or S 50).

Subsequently, the luminance data of the original macro-block OMB having the pixel count which corresponds to the memory bus width is read out from the memory 22 (Step 51 or S51). For example, when the memory bus width is 32 bits and the luminance data of each pixel is 8 bits, 4 pixels' worth of the luminance data is read out at each time.

Next, the luminance data of the reference macro-block RMB having the pixel count which corresponds to the memory bus width is read out from the memory 22 (Step 52 or S52) and the luminance data is stored in the input buffer (Step 53 or S53). This process is repeated until the luminance data of the reference macro-block RMB gets ready (Step 54: N).

When the luminance data of the reference macro-block RMB is ready (Step 54: Y), a pixel value of the half pixel position is calculated (Step 55 or S55). The pixel value of the half pixel position is not stored in the memory 22 so that it is needed to be freshly calculated by using the pixel value of the integer pixel position. To be more specific, it is derived from the above-described formula (1) or (2) by using the luminance data of the two or four integer pixel positions in the way described with reference to FIG. 9.

The error of the luminance data is then calculated by using the luminance data of the half pixel position obtained in Step 55 (Step 56 or S 56). In other words, the error between the luminance data of the integer pixel position in the original macro-block OMB read out in Step 51 and the luminance data of the half pixel position in the reference macro-block RMB as of Step 54 is calculated. For example, if the half pixel position “a′” is selected in Step 50, the error between the half pixel position hp0-5 in the reference macro-block RMB and the integer pixel position fp5 in the original macro-block OMB shown in FIG. 9 will be calculated. In this manner, for example, four pixels' worth of the errors between the luminance data of these macro-blocks can be calculated at one time. In the error calculation in Step 56, an absolute value of the error obtained by pixels is cumulated.

Subsequently, the position in the macro-block is renewed in order to calculate the next error (Step 57 or S57). If the evaluations of all the pixels in the macro-block are not finished yet (Step 58: N), return to Step 51. If the evaluations of all the pixels in the macro-block are finished (Step 58: Y), whether the error obtained in Step 58 is smaller than the minimum error which is the error at the minimum error position or not is judged (Step 59 or S59). When the obtained error is considered to be smaller than the minimum error (Step 59: Y), the minimum error position is updated with the position (one of the positions “a′-h′”) which is selected in order to calculate the error (Step 60 or S60).

In Step 59, if the obtained error is considered to be equal or larger than the minimum error (Step 59: N), or if the evaluations of the all the positions “a′-h′” whether they are the minimum error positions or not are not finished yet after Step 60 (Step 61: N), return to Step 50.

In Step 61, when the evaluations of the all the positions “a′-h′” whether they are the minimum error positions or not are finished (Step 61: Y), a series of the processes is ended (END).

As described above, in the error operation process with the half pixel accuracy in the comparative example, every time the pixel position is renewed in the macro-block, the luminance data of the original macro-block OMB and the reference macro-block RMB are read out, the luminance data at the half pixel position is calculated and the error between each half pixel position and the corresponding integer pixel position has to be further calculated. This process is repeated for the eight half pixel positions. Therefore, the operation of the half pixel position is redundantly performed even though each half pixel position is shared by two or four integer pixel positions. In addition, memory access for reading out data occurs frequently and it takes a long time to process the error operation with the half pixel accuracy.

Focusing attention on the fact that each of the eight half pixel positions is shared by the two or four integer pixel positions, pixel values of a plurality of the half pixel positions are calculated every time the pixel value of the integer pixel position is read out from the memory 22 in this embodiment. The half pixel positions are specified by the integer pixel positions and the old integer pixel positions that are read out in the past. Particularly, because the pixel value of the half pixel position is calculated by using the pixel values of the integer pixel positions which are adjacent each other in the vertical direction, the pixel values of the integer pixel positions that align in a first horizontal line of the block are sequentially read out starting from the integer pixel position placed in the outer side of the block. In this way, the operation of the half pixel position will not be redundantly performed and unnecessary memory access will be reduced. Here, the old integer position read out in the past is a position which is adjacent to the integer pixel position at least in one of the vertical direction and the horizontal direction.

Furthermore, when the error calculation between the half pixel position and the corresponding integer pixel position is possible, the error calculation is performed every time the pixel value of the half pixel position is calculated. Consequently, the process of the image difference calculation with the half pixel accuracy can be speeded up and it is possible to perform the motion estimation, which could be a problem in the series of the encoding processes, more accurately and at a higher speed.

Such embodiment of the present invention will be described below.

In the motion estimation, the motion vector has to be generated by the macro-block. In this embodiment, the macro-block is divided in quarters and the error operation is performed by the block. The error of the macro-block can be obtained based on the error calculated by the block.

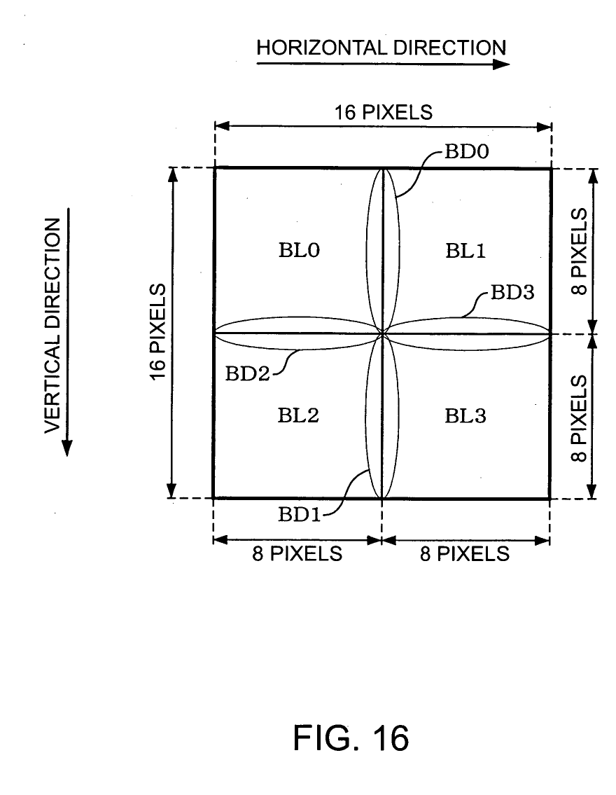

FIG. 16 shows a relation between the macro-block and the block in this embodiment.

The macro-block is a rectangular area which consists of 16 pixels aligning in the horizontal direction and 16 pixels aligning in the vertical direction. On the other hand, the block is a rectangular area which consists of 8 pixels aligning in the horizontal direction and 8 pixels aligning in the vertical direction. Therefore, blocks BL0 and BL1 (a first block and a second block) align in the horizontal direction and blocks BL2 and BL3 (a third block and a fourth block) also align in the horizontal direction. Furthermore, the blocks BL0 and BL2 (the first block and the third block) align in the vertical direction and the blocks BL1 and BL3 (the second block and the fourth block) also align in the vertical direction.

Here, a part of the half pixel positions placed around the eight integer pixel positions in the vertical direction is shared at the boundary between the block BL0 and the block BL1 (BD0). In the same manner, a part of the half pixel positions placed around the eight integer pixel positions in the vertical direction is shared at the boundary between the block BL2 and the block BL3 (BD1). Furthermore, a part of the half pixel positions placed around the eight integer pixel positions in the horizontal direction is shared at the boundary between the block BL0 and the block BL2 (BD2). In the same manner, a part of the half pixel positions placed around the eight integer pixel positions in the horizontal direction is shared at the boundary between the block BL1 and the block BL3 (BD3).

In this embodiment, when the error is calculated with the half pixel accuracy in each block which is the quarter of the macro-block, an operation of the half pixel position which is shared by the adjacent blocks is performed in only one of the blocks. In this way, it can prevent the operation of the half pixel position shared by the adjacent blocks from being redundantly calculated.

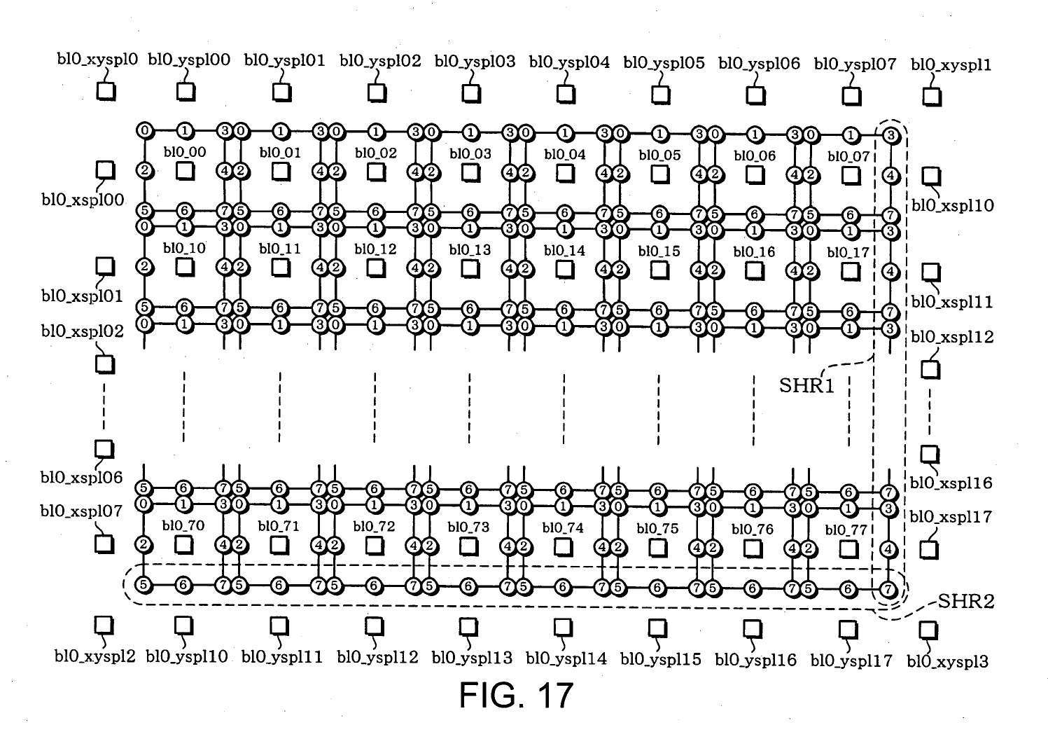

FIG. 17 schematically shows the integer pixel position and the half pixel position of the block BL0 in FIG. 16. Though the block BL 0 is shown here, it is the same for the block BL 2.

In the block BL 0, the eight integer pixel positions align in the horizontal direction. And eight of this set of the horizontal eight integer pixel positions are lined up in the vertical direction. Accordingly, when the eight half pixel positions around the one integer pixel position are specified as described in FIG. 9, three half pixel positions are shared by the two adjacent integer pixel positions.

For example, half pixel positions which correspond to the half pixel positions hp1-5, hp2-5, hp4-5 and hp6-5 shown in FIG. 9 are shared by the two integer pixel positions that are adjacent to them. Half pixel positions which correspond to the half pixel positions hp0-5, hp3-5, hp5-5 and hp7-5 shown in FIG. 9 are shared by the surrounding four integer pixel positions.

In the half pixel positions which are specified by the integer pixel positions composing the block BL0, a half pixel position group SHR1 consists of the half pixel positions placed on the right side of the integer pixel positions bl0_07, bl0_17 . . . bl0_77 can be shared as a half pixel position group specified by the integer pixel positions composing the block BL1. Furthermore, in the half pixel positions which are specified by the integer pixel positions composing the block BL0, a half pixel position group SHR2 consists of the half pixel positions placed on the lower side of the integer pixel positions bl0_70, bl0_71 . . . bl0_77 can be shared as a half pixel position group specified by the integer pixel positions composing the block BL2.

Though the block BL 0 is shown in FIG. 17, it is the same for the block BL 2. In other words, in the half pixel positions which are specified by the integer pixel positions composing the block BL2, a half pixel position group consists of the half pixel positions placed on the right side of the integer pixel positions bl2_07, bl2_17 . . . bl2_77 can be shared as a half pixel position group specified by the integer pixel positions composing the block BL3. Furthermore, in the half pixel positions which are specified by the integer pixel positions composing the block BL2, a half pixel position group consists of the half pixel positions placed on the upper side of the integer pixel positions bl2_00, bl2_01 . . . bl2_07 can be shared as the half pixel position group SHR2 specified by the integer pixel positions composing the block BL0.

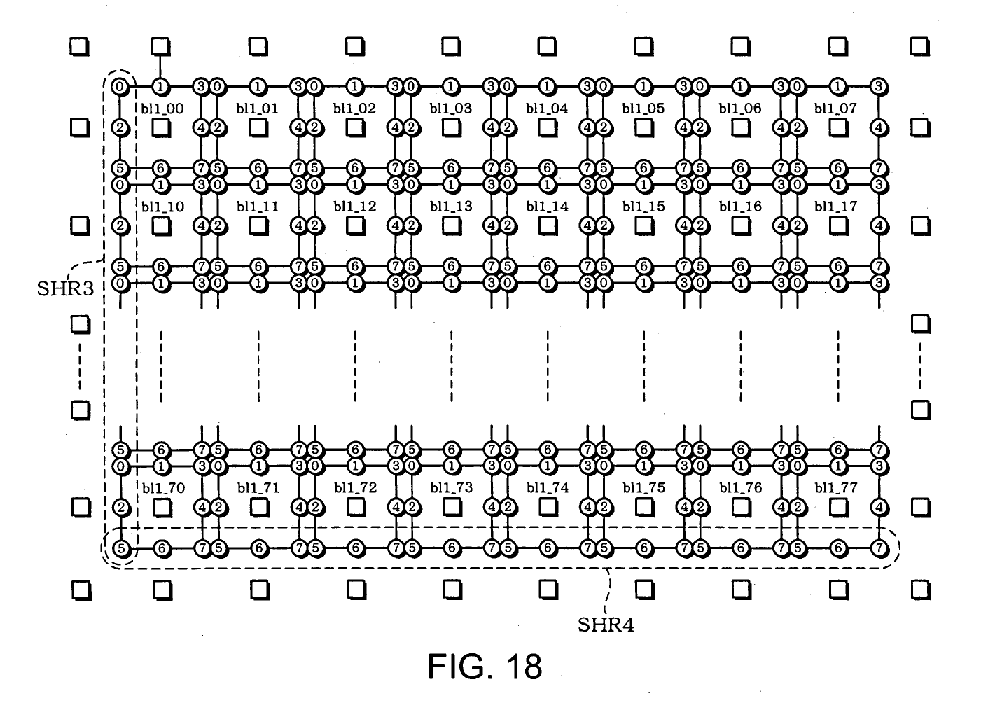

FIG. 18 schematically shows the integer pixel position and the half pixel position of the block BL1 in FIG. 16. Though the block BL 1 is shown here, it is the same for the block BL 3.

In the block BL 1, the eight integer pixel positions align in the horizontal direction. And eight of this set of the horizontal eight integer pixel positions are lined up in the vertical direction. Therefore, in the same way as FIG. 17, when the eight half pixel positions around the one integer pixel position are specified as described in FIG. 9, the three half pixel positions are shared by the two adjacent integer pixel positions.

In the half pixel positions which are specified by the integer pixel positions composing the block BL1 shown in FIG. 18, a half pixel position group SHR3 consists of the half pixel positions placed on the left side of the integer pixel positions bl1_00, bl1_10 . . . bl1_70 aligning in the most left side can be shared as the half pixel position group SHR1 specified by the integer pixel positions composing the block BL0. Furthermore, in the half pixel positions which are specified by the integer pixel positions composing the block BL1, a half pixel position group SHR4 consists of the half pixel positions placed on the lower side of the integer pixel positions bl1_70, bl1_71 . . . bl1_77 aligning in the bottom line can be shared as a half pixel position group specified by the integer pixel positions composing the block BL3.

Though the block BL 1 is shown in FIG. 18, it is the same for the block BL 3. In other words, in the half pixel positions which are specified by the integer pixel positions composing the block BL3, a half pixel position group consists of the half pixel positions placed on the left side of the integer pixel positions bl3_00, bl3_10 . . . bl3_70 aligning in the most left side can be shared as a half pixel position group specified by the integer pixel positions composing the block BL2. Furthermore, in the half pixel positions which are specified by the integer pixel positions composing the block BL3, a half pixel position group consists of the half pixel positions placed on the upper side of the integer pixel positions bl3_00, bl3_01 . . . bl3_07 aligning in the top line can be shared as the half pixel position group SHR4 specified by the integer pixel positions composing the block BL3.

The pixel values of the integer pixel positions which align in the horizontal direction of the reference image and used for obtaining the half pixel positions are sequentially stored in the memory in the vertical direction of the reference image. Therefore, data will be read out from this memory in the vertical direction of the reference image and in order of the integer pixel position aligning in the horizontal direction of the reference image.

Focusing attention on such order to read out the integer pixel positions and the fact that half pixel positions in each block are shared as described above, the half pixel position is calculated from a plurality of integer pixel positions every time the pixel value of the integer pixel position in the block is read out from the memory in this embodiment.

For example, in order to calculate the pixel values of the half pixel positions around the integer pixel positions bl0_00-bl0_07, bl0_10-bl0_17 . . . bl0_70-bl0_77 in the block shown in FIG. 17, the pixel values of the integer pixel positions which are placed outside the following blocks. In other words, in order to obtain the half pixel positions placed on the upper side of the integer pixel positions bl0_00, bl0_01 . . . bl0_07, the pixel values of integer pixel positions bl0_xyspl0, bl0_yspl00, bl0_yspl01 . . . bl0_yspl07 and bl0_xyspl1 are needed. In order to obtain the half pixel positions placed on the left side of the integer pixel positions bl0_00, bl0_10 . . . bl0_70, the pixel values of integer pixel positions bl0_xyspl0, bl0_xspl00, bl0_xspl01 . . . bl0_xspl07 and bl0_xyspl2 are needed. In order to obtain the half pixel positions placed on the lower side of the integer pixel positions bl0_70, bl0_71 . . . bl0_77, the pixel values of integer pixel positions bl0_xyspl2, bl0_yspl10, bl0_yspl11 . . . bl0_yspl17 and bl0_xyspl3 are needed. Furthermore, in order to obtain the half pixel positions placed on the right side of the integer pixel positions bl0_07, bl0_17 . . . bl0_77, the pixel values of integer pixel positions bl0_xyspl1, bl0_xspl10, bl0_×spl11 . . . bl0_xspl17 and bl0_xyspl3 are needed. In this way, the pixel values of the half pixel positions around the integer pixel position in the block can be sequentially calculated every time the pixel value of the integer pixel position is read out because it is successively read out starting from the one of the integer pixel position placed in the outer side of the block.

By doing this, redundant memory access will be prevented and the overlapping operation of the half pixel position can be omitted.

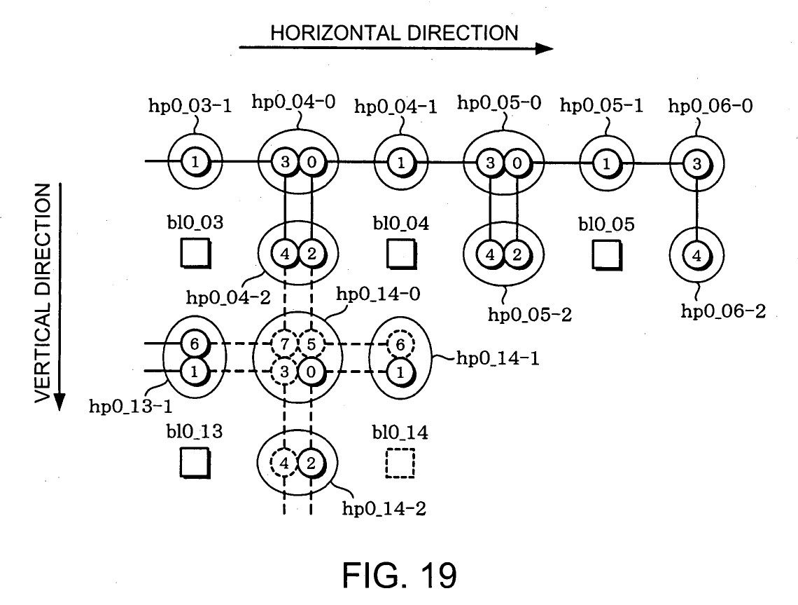

FIG. 19 is an explanatory drawing for the operation of the half pixel position in this embodiment. In FIG. 19, the same structures as those in FIG. 17 are given the identical numerals and those explanations will be omitted.

The figure shows a half way state in which data is sequentially read out from the memory in the vertical direction of the reference image and in order of the integer pixel position aligning in the horizontal direction of the reference image. In other words, the pixel values of the integer pixel positions bl0_03, bl0_04, bl0_05 . . . bl0_13 are being read out. In this state, the pixel values of the half pixel positions hp0_03-1, hp0_04-0, hp0_04-1, hp0_04-2, hp0_05-0, hp0_05-1, hp0_05-2, hp0_06-0, hp0_06-2 . . . hp0_13-1 have been already obtained.

Consider the case where the pixel value of the integer pixel position bl0_14 of the reference image is going to be read out in this state. When the pixel value of the integer pixel position bl0_14 turns out, the pixel values of the following three half pixel positions can be calculated. Such three half pixel positions are the half pixel position hp0_14-2 specified by the integer pixel positions bl0_13 and bl0_14, the half pixel position hp0_14-0 specified by the integer pixel positions bl0_03, bl0_04, bl0_13 and bl0_14, and the half pixel position hp0_14-1 specified by the integer pixel positions bl0_04 and bl0_14. Since each half pixel position is shared, to obtain the pixel values of these three half pixel positions means that to obtain the pixel values of eight half pixel positions. This means that the process load can be reduced by that much.

As described above, every time the pixel value of the integer pixel position in the block (predetermined area) is read out, the pixel values of the plurality of the half pixel positions can be calculated based on the pixel value of the integer pixel position and pixel values of first through third integer pixel positions in this embodiment. The plurality of the half pixel positions includes half pixel positions which are specified by the integer pixel position, the first integer pixel position which is adjacent to the integer pixel position in the horizontal direction, the second integer pixel position which is adjacent to the integer pixel position in the vertical direction, and the third integer pixel position which is adjacent to the first integer pixel position in the vertical direction and adjacent to the second integer pixel position in the horizontal direction.

In FIG. 19, the case that the one integer pixel position bl0_14 is read out was described. For example, if it is possible to read out the pixel values of four pixel integer positions at a time, the pixel values of twelve half pixels positions can be obtained at one time according to the embodiment because the pixel values of the three half pixel positions can be obtained with respect to the pixel value of each integer pixel position.

Furthermore, as described above with reference to FIG. 17 and FIG. 18, the half pixel position group (SHR 1, SHR3) is shared by the horizontally adjacent blocks BL0 and BL1 and the other horizontally adjacent blocks BL2 and BL3. In the same way, the half pixel position group (SHR 2, SHR4) is shared by the vertically adjacent blocks BL0 and BL2 and the other vertically adjacent blocks BL1 and BL3. Therefore, when the pixel value of the half pixel position is calculated in the above-described way, it is preferred that the pixel value of the half pixel position which is shared by the horizontally adjacent blocks is calculated in either block. It is also preferred that the pixel value of the half pixel position which is shared by the vertically adjacent blocks is calculated in either block. In this way, some of the operations for the pixel value of the half pixel position can be skipped and it is possible to further reduce the process load.

Moreover, a difference between the obtained half pixel position and the corresponding integer pixel position of the present image is calculated. In other words, the half pixel position which depends on the plurality of the integer pixel positions is calculated every time the pixel value of the integer pixel position in the block from the memory. And then, the difference between the obtained half pixel position and the corresponding integer pixel position of the present image is calculated.

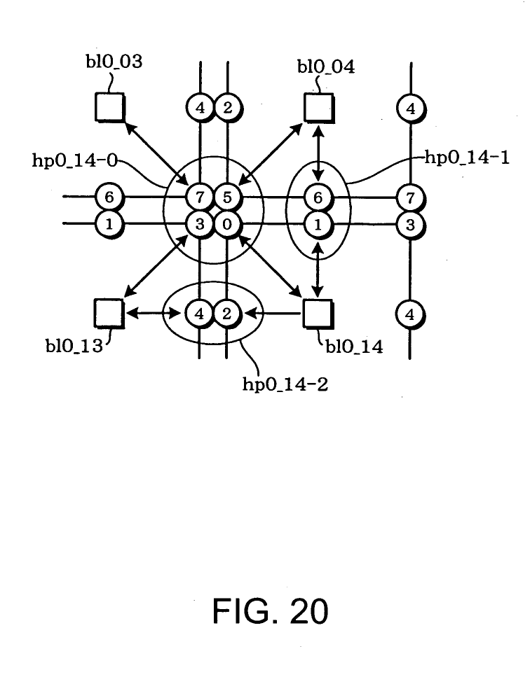

FIG. 20 is an explanatory drawing of the error operation of the embodiment. In FIG. 20, the same structures as those in FIG. 19 are given the identical numerals and those explanations will be omitted.

In this embodiment, one obtained pixel value of the half pixel position in the reference image is compared with the pixel value of the corresponding integer pixel position in the present image. For example, the pixel value of the half pixel position hp0_14-0 in the reference image is not only compared with the pixel value of the integer pixel position bl0_03 in the present image but also compared with each pixel value of the integer pixel positions bl0_04, bl0_13 and bl0_14 in the present image. The absolute error is obtained from each comparison process and each summation of absolute errors is then calculated.

The summation of absolute errors obtained by the block in the above-described way can be evaluated as the error by the macro-block because the motion vector is calculated at the minimum error position where the summation of absolute errors calculated by the macro-block becomes a minimum.

A process example of the error operation with the half pixel accuracy in the above-described embodiment will be described.

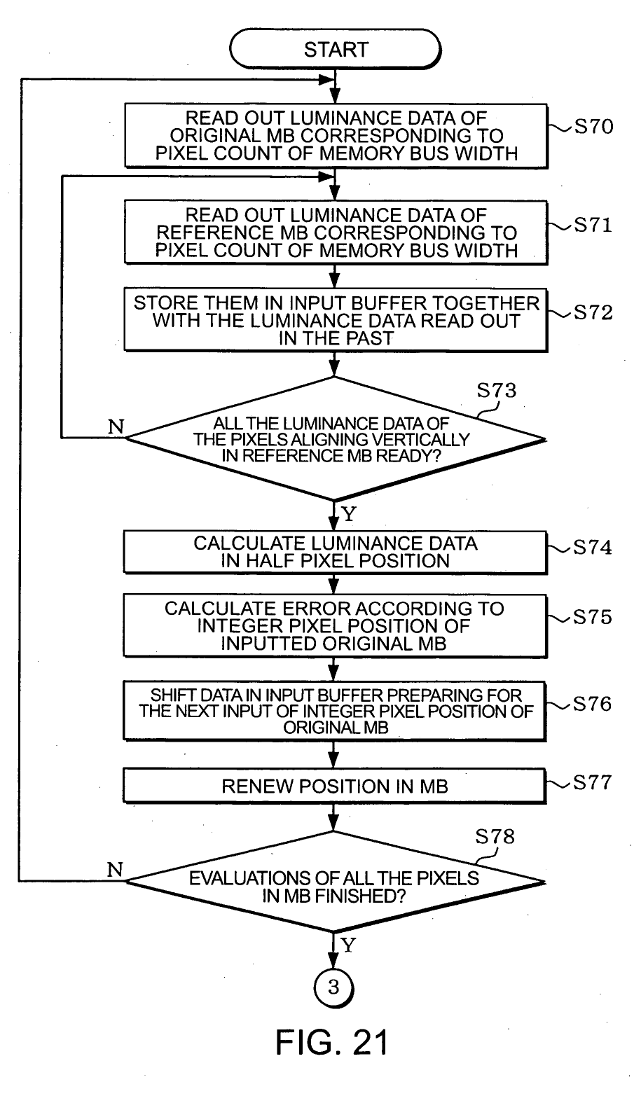

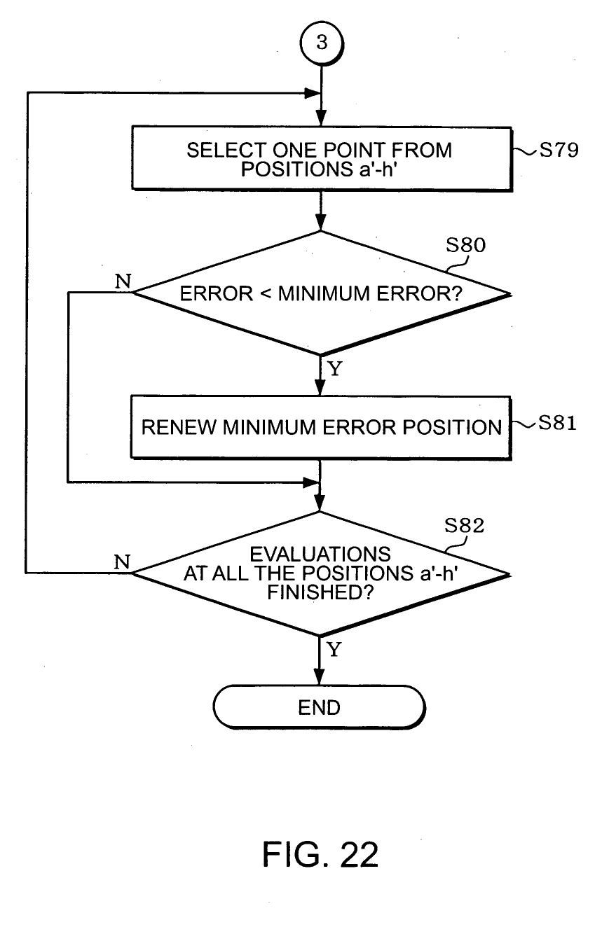

FIG. 21 and FIG. 22 is a flow of the process example of the error operation with the half pixel accuracy in the embodiment.

In case of this embodiment, it is not necessary to read out the luminance data (pixel value in a broad sense) one by one with respect to the half pixel position from the memory as shown in FIG. 14. Therefore, firstly, the luminance data of the original macro-block OMB having the pixel count which corresponds to the memory bus width is read out from the memory 22 (Step 70 or S70). For example, when the memory bus width is 32 bits and the luminance data of each pixel is 8 bits, 4 pixels' worth of the luminance data is read out at each time.

Next, the luminance data of the reference macro-block RMB having the pixel count which corresponds to the memory bus width is read out from the memory 22 (Step 71 or S71). In this embodiment, the luminance data of the vertically adjacent integer pixel position is also stored in the input buffer at the same time. The luminance data of the reference macro-block RMB which is read out in Step 71 and the luminance data which was read out in the past are stored together in the input buffer (Step 72 or S72). This process is repeated until the luminance data of the reference macro-block RMB are all ready (Step 73: N).

When the luminance data of the reference macro-block RMB is ready (Step 73: Y), the pixel value of the half pixel position is calculated (Step 74 or S74). As described above with reference to FIG. 9, the pixel value of the half pixel position is derived from the above-described formula (1) or (2) by using the luminance data of the two or four integer pixel positions. For example, as described above with reference to FIG. 19, luminance data of the three half pixel positions are obtained from the one integer pixel position.

The error of the luminance data is then calculated by using the luminance data of the half pixel position obtained in Step 74 (Step 75 or S 75). In other words, as described with reference to FIG. 20, the error between the luminance data of the integer pixel position in the original macro-block OMB read out in Step 70 and the luminance data of the half pixel position in the reference macro-block RMB obtained in Step 74 is calculated.

In this embodiment, unless all the integer pixel positions are read out, the error operations of the all half pixel position cannot be ended. Therefore, the result of the error operation in Step 75 is retained and the absolute value if the error is cumulated each time the half pixel position is calculated.

Subsequently, data is shifted in the input buffer in order to prepare for the input of the next integer pixel position (Step 76 or S76). The position in the macro-block is then renewed in order to calculate the next error (Step 77 or S77).

If the evaluations of all the pixels in the macro-block are not finished yet (Step 78: N), return to Step 70. If the evaluations of all the pixels in the macro-block are finished (Step 78: Y), one position is selected form the half pixel positions “a′-h′” which depends on the variable “DIS” (Step 79 or S79). At this point, the summation of the absolute errors between the position and the integer pixel position of the original macro-block OMB is calculated with respect to each of the half pixel positions “a′- h′”.

Then, it is judged that whether the error of the selected half pixel position in Step 79 is smaller than the minimum error which is the error at the minimum error position or not (Step 80 or S80). When the obtained error is considered to be smaller than the minimum error (Step 80: Y), the minimum error position is updated with the position (one of the positions “a′-h′”) which is selected to calculate the error (Step 81 or S81).

In Step 80, if the obtained error is considered to be equal or larger than the minimum error (Step 80: N), or if the evaluations of the all the positions “a′-h′” whether they are the minimum error positions or not are not finished yet after Step 81 (Step 82: N), return to Step 79.

In Step 82, when the evaluations of the all the positions “a′-h′” whether they are the minimum error positions or not are finished (Step 82: Y), a series of the processes is ended (END).

According to the embodiment, the luminance data of the half pixel position is calculated and the absolute difference between the half pixel position and the calculable integer pixel position is obtained every time the luminance data of the integer pixel position is read out. The summation of the absolute differences of all the half pixel positions can be calculated by reading out the luminance data of all the integer pixel positions. At the end, a smallest one is selected from the summations of the absolute differences which are obtained with respect to each half pixel position.

4. Hardware Configuration Example

Next, a hardware configuration example of the motion estimation part 24 shown in FIG. 1 which performs the above-described image difference operation will be described.

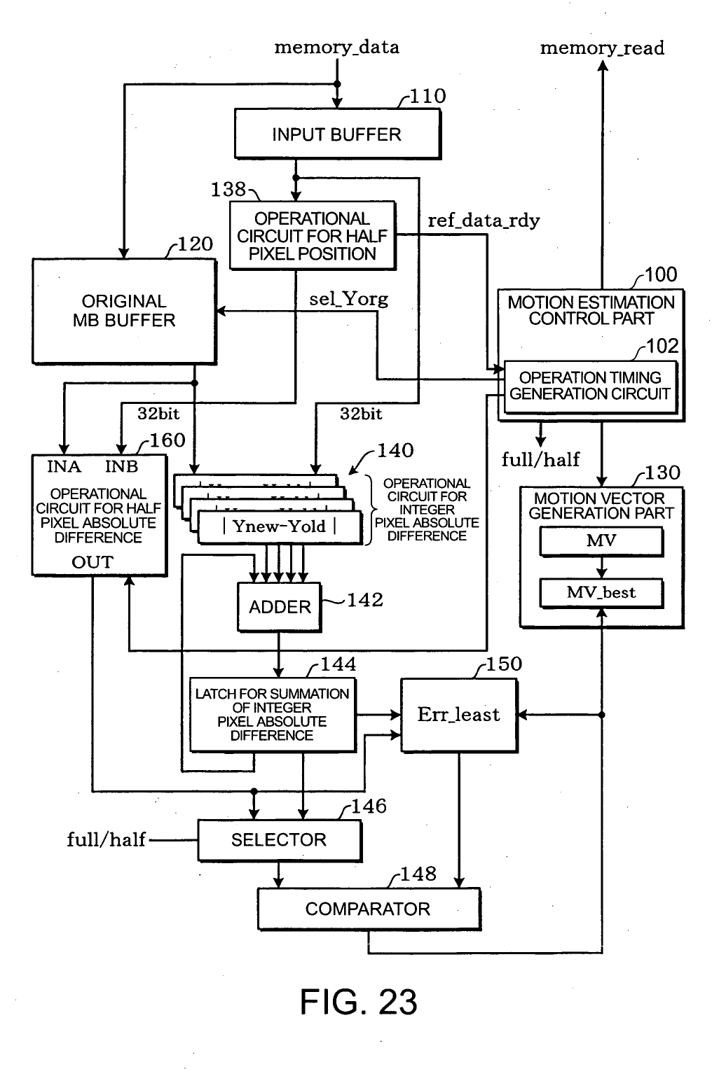

FIG. 23 is a block diagram of the hardware configuration example of the motion estimation part 24 shown in FIG. 1.

In the motion estimation part 24, the luminance data of the reference macro-block RMB in the reference image, which is read out by a memory readout request signal “memory_read” sent from a motion estimation control part 100 to the memory 22, is stored in an input buffer 110. Here, the reference image is the old input image when the difference of the image is calculated with the integer pixel accuracy. When the difference of the image is calculated with the half pixel accuracy, the reference image is the local decode image. This input buffer 110 has a data capacity which is large enough to store the luminance data of the integer pixel positions aligning in the vertical direction of the image. In FIG. 23, the input buffer has a capacity of 4 pixels×5 access times in order to reduce the number of memory accesses as much as possible because the difference operation is conducted every four pixels by reading the luminance data by a unit of four pixels in each block from the memory 22. This is because when the difference calculation is performed every four pixels, some motion vectors MV requires the pixel value of the integer pixel position in the reference image to be read up to four times. In addition, the pixel values of the vertically adjacent integer pixel positions in the reference image are also needed.

The luminance data of the original macro-block OMB from the memory 22 is stored in an original macro-block buffer 120.

Though it is described that the motion vector between the images is obtained such that the difference between the local decode image and the new input image becomes a minimum in the above description, the motion estimation part 24 shown in FIG. 23 firstly calculates the reference macro-block RMB which is at a position where the motion vector MV generated by a motion vector generation part 130 shows based on the original macro-block OMB. The luminance data of these two images at the time are then compared to each other. In other words, the motion vector Mv at which the difference between the two images becomes smallest is renewed as the motion vector MV generated by the motion vector generation part 130 is changed. A final result of the motion vector “MV_best” is then outputted. At this time, the summation of the absolute difference of the image is calculated by the block and stored, and a position where the difference of the image becomes a minimum can be calculated by each macro-block. Such motion vector generation part 130 is controlled by the motion estimation control part 100.

The motion estimation part 24 includes an operational circuit 138 for the half pixel position (an operation part for the half pixel position in a broad sense). The operational circuit 138 for the half pixel position can obtain the pixel values of four pixel positions at one time by using the luminance data of the integer pixel position stored in the input buffer 110.

The motion estimation part 24 further includes an operational circuit 140 for the integer pixel absolute difference, an adder 142, an latch144 for the summation of the integer pixel absolute difference, a selector 146, a comparator 148, a minimum error storing register 150 and an operational circuit 160 for the half pixel absolute difference (a difference operation part in a broad sense). The operational circuit 140 for the integer pixel absolute difference calculates four pixels' worth of absolute difference between the luminance data of the integer pixel position stored in the input buffer 110 and the luminance data of the integer pixel position stored in the original macro-block buffer 120 at one time. The adder 142 adds the summation of the differences stored in the latch 144 for the summation of the integer pixel absolute difference and the four pixels' worth of summations of the differences obtained from the operational circuit 140 for the integer pixel absolute difference. The latch 144 for the summation of the integer pixel absolute difference latches the output from the adder 142.

The operational circuit 160 for the half pixel absolute difference calculates four pixels' worth of the absolute difference between the luminance data of the half pixel position obtained by the operational circuit 138 for the half pixel position and the luminance data of the integer pixel position stored in the original macro-block buffer 120 at one time. The selector 146 selects either the output from the operational circuit 160 for the half pixel absolute difference or the output from the latch 144 for the summation of the integer pixel absolute difference. To be more specific, the selector 146 selects the output from the operational circuit 160 for the half pixel absolute difference when the difference is calculated with the half pixel accuracy. When the difference is calculated with the integer pixel accuracy, the selector 146 selects the output from the latch 144 for the summation of the integer pixel absolute difference.

The comparator 148 compares the output of the selector 146 with the minimum error value stored in the minimum error storing register 150. When the output of the selector 146 is smaller than the minimum error, the comparator 148 makes the output active. When the operational circuit 160 for the half pixel absolute difference is selected and the output of the comparator 148 becomes active, the output of the operational circuit 160 for the half pixel absolute difference is stored in the minimum error storing register 150. If the latch 144 for the summation of the integer pixel absolute difference is selected and the output of the comparator 148 becomes active, the output of the latch 144 for the summation of the integer pixel absolute difference is stored in the minimum error storing register 150.

An image difference calculating device in this embodiment may include such input buffer 110, the original macro-block buffer 120, the operational circuit 138 for the half pixel position, the operational circuit 140 for the integer pixel absolute difference, the adder 142, the latch 144 for the summation of the integer pixel absolute difference, the selector 146, the comparator 148, the minimum error storing register 150 and the operational circuit 160 for the half pixel absolute difference. These components are controlled according to a control signal from an operation timing generation circuit 102 in the motion estimation control part 100. The image difference calculating device may be composed without having some of the above-mentioned components.

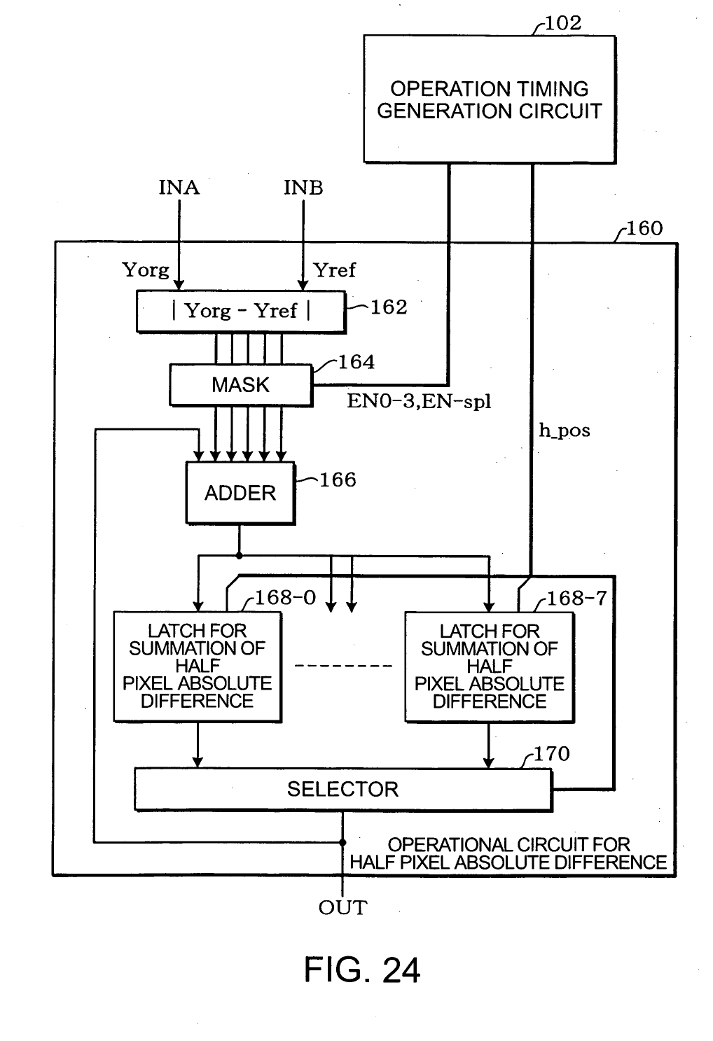

FIG. 24 is a block diagram of a configuration example of the operational circuit 160 for the half pixel absolute difference shown in FIG. 23.

In the operational circuit 160 for the half pixel absolute difference, an absolute difference operational circuit 162 calculates the summation of the difference by using the luminance data of the integer pixel position from the original macro-block buffer 120 and the luminance data of the half pixel position obtained from the operational circuit 138 for the half pixel position. The summation of the differences obtained by the absolute difference operational circuit 162 is controlled by a mask circuit 164 based on a mask control signal sent from the operation timing generation circuit 102. The operational circuit 160 for the half pixel absolute difference can calculate five pixels' worth of the summation of the absolute differences at each integer pixel position at one time. Only necessary summation of the differences is provided to an adder 166 by the mask circuit 164.

The operational circuit 160 for the half pixel absolute difference has latches 168-0 though 168-7 for the summation of the half pixel absolute differences. The latch for the summation of the half pixel absolute differences is provided with respect to each half pixel position. The summation of the absolute differences of the half pixel position which is specified by the operation timing generation circuit 102 is stored in the corresponding latch for the summation of the half pixel absolute differences. At the same time, the summation of absolute differences stored in the latch for the summation of the half pixel absolute differences which corresponds to the half pixel positions specified by the operation timing generation circuit 102 is selected by a selector 170.

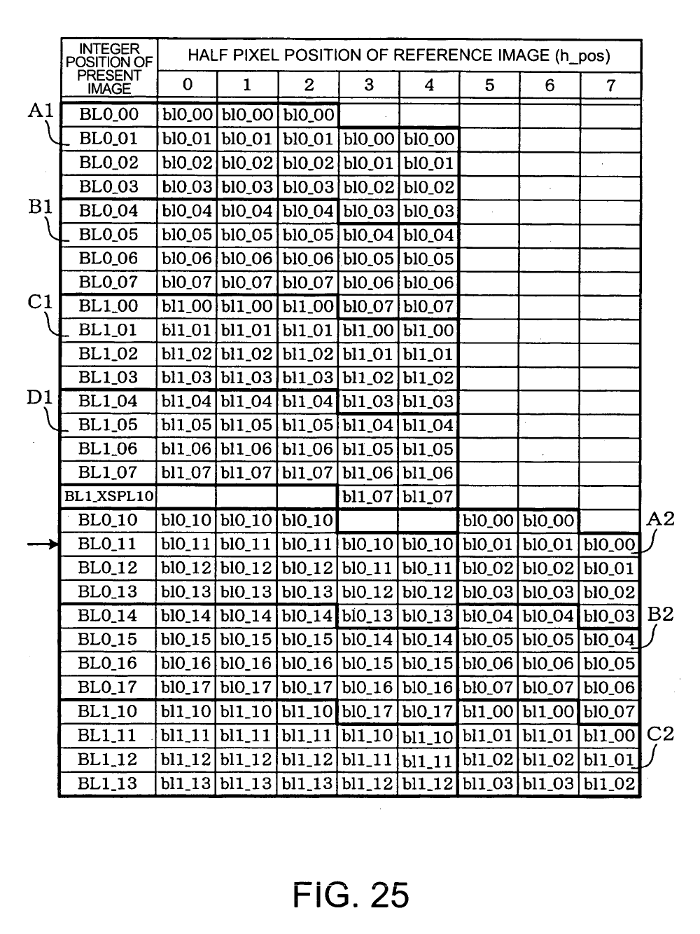

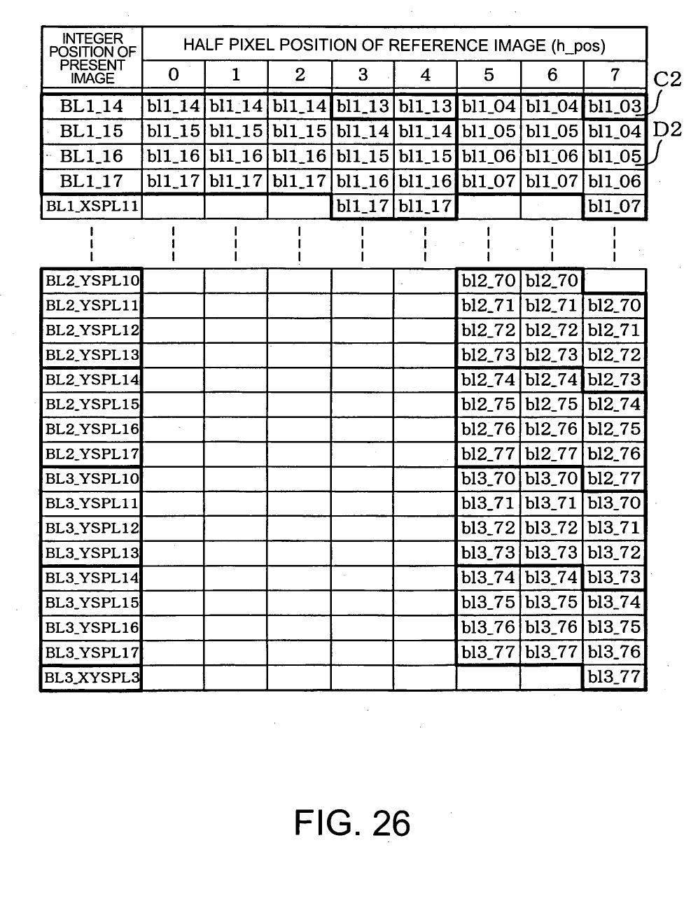

FIG. 25 and FIG. 26 are drawings for explaining a movement example of the operation timing generation circuit 102. Each time the luminance data of an integer pixel position in the reference image is inputted, a half pixel position of the integer pixel position is calculated. This half pixel position is specified by a half pixel position specifying signal “h_pos”. A number which the half pixel position specifying signal “h_pos” specifies corresponds to a number of the half pixel position shown in FIG. 17 thorough FIG. 20. The difference between the pixel value of this half pixel position and the pixel value of the integer pixel position in the present image can be calculated. Enable signals ENO-3 specify the half pixel position which is capable of error calculation.

For example, when a pixel value of the integer pixel position bl0_00 in the reference image is inputted, half pixel positions hp0_00-0 (h_pos=0), hp0_00-1 (h_pos=1) and hp0_00-2 (h_pos=2) around the integer pixel position bl0_00 are calculated. A pixel value of an integer pixel position BL0_00 in the block BL0 of the present image, which corresponds to the integer pixel position bl0_00 in the reference image, is then calculated. A pixel value of the obtained half pixel position is also calculated.

An enable signal “EN-spl” is used to obtain the summation of the differences base on the obtained half pixel position when, for example, the integer pixel position outside the block is read out.

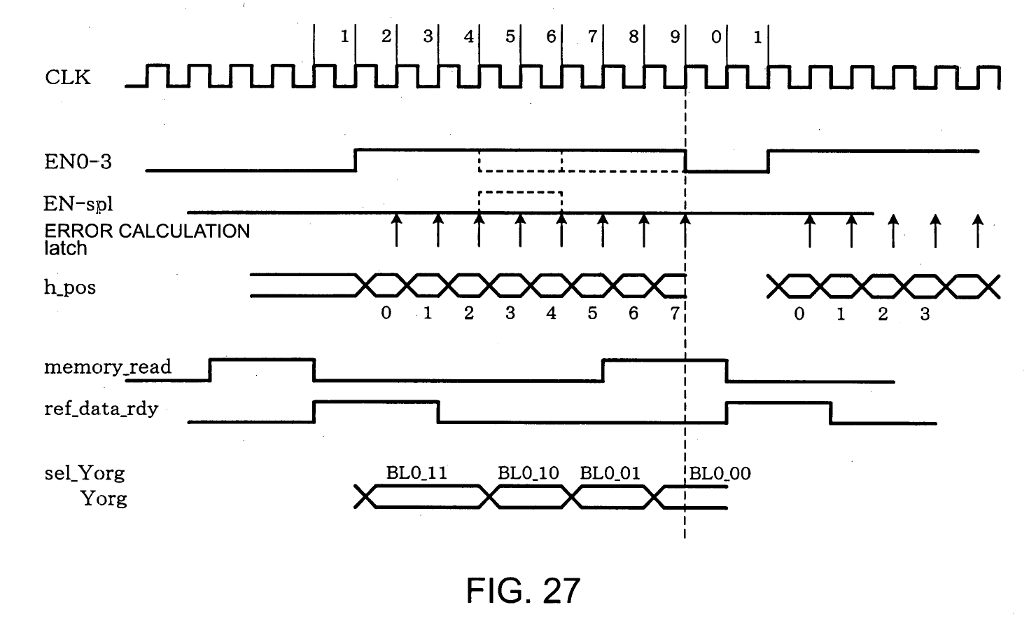

FIG. 27 is a timing chart of an operation example of the motion estimation part 24 shown in FIG. 24.

The timing chart in FIG. 27 will be explained with reference to FIG. 25 and FIG. 26. Here, each component in the motion estimation part 24 moves based on a clock signal CLK.

When a pixel value of the integer pixel position bl0_11 in FIG. 25 is read out, the memory readout request signal “memory_read” is firstly outputted to the memory 22. Then, when the reference image gets ready in the input buffer 110, a completion signal “ref_data_rdy” becomes active.

In this case, referring to FIG. 25, pixel values of half pixel positions hp0_11-0 (h_pos=0), hp0_11-1 (h_pos=1), hp0_11-2 (h_pos=2), hp0_10-3 (h_pos=3), hp0_10-4 (h_pos=4), hp0_01-5 (h_pos=5), hp0_01-6 (h_pos=6) and hp0_00-7 (h_pos=7) are calculated. Therefore, the enable signals EN0-3 become active as long as the half pixel position specifying signal h_pos is 0-7.

The operation timing generation circuit 102 orders the original macro-block buffer 120 to output a pixel value of an integer pixel position BL0_11 when the half pixel position specifying signal h_pos is 0-2. When the half pixel position specifying signal h_pos is 3 and 4, a pixel value of an integer pixel position BL0_10 is outputted from the original macro-block buffer 120. The operation timing generation circuit 102 also orders the original macro-block buffer 120 to output a pixel value of an integer pixel position BL0_01 when the half pixel position specifying signal h_pos is 5 and 6. When the half pixel position specifying signal h_pos is 7, the pixel value of the integer pixel position BL0_00 is outputted from the original macro-block buffer 120.

In this way, for example, a summation of absolute differences of the integer pixel positions BL0_00 through BL0_03 is calculated by the four pixels when the control process shown in A1 and A2 in FIG. 25 and FIG. 26 is finished.

The present invention is not limited to the above-described embodiments but applied to various kinds of modifications within the scope and spirit of the present invention.

Though the pixel values of the integer pixel position and the half pixel position are described as the luminance data in this embodiment, the case is not limited to this. Furthermore, though the difference of the pixel value of the half pixel position is calculated in this embodiment, the present invention can be applied to a case that a difference of a quarter pixel position, which can be derived from the plurality of the half pixel positions, is calculated. Moreover, though the motion estimation device is applied to the encoding process of MPEG-4 in this embodiment, the motion estimation device of the present invention can be applied to other encoding process including H.246.

In inventions according to the dependent claims laid out herein, note that a part of the components appear in the independent claim may be omitted. Also note that essential parts of the independent claim may depend on other independent claim.

1. A method for calculating an image difference between a present image and a reference image that is older than the present image by each predetermined area, comprising:
reading out a pixel value of a integer pixel position from a memory in a vertical direction of the reference image while sequentially reading out the pixel value in order of the integer pixel position that aligns in a horizontal direction of the reference image starting from a first integer pixel position placed in an outer side of the predetermined area in the reference image;
calculating pixel values of a plurality of half pixel positions, which are specified by the integer pixel position and a plurality of second integer pixel positions that are adjacent to the integer pixel position and read out before the integer pixel position, based on the pixel value of the integer pixel position and a pixel value of the second integer pixel position every time the pixel value of the integer pixel position in the predetermined area is read out; and
calculating a difference between a pixel value of a half pixel position that is one of the plurality of the half pixel positions in the reference image and a pixel value of a third integer pixel position corresponding to the half pixel position in the present image.

2. The method for calculating an image difference according to claim 1, wherein the pixel values of the plurality of the half pixel positions, which are specified by the integer pixel position, a fourth integer pixel position adjacent to the integer pixel position in the horizontal direction, a fifth integer pixel position adjacent to the integer pixel position in the vertical direction and a sixth integer pixel position adjacent to the fourth integer pixel position in the vertical direction and adjacent to the fifth integer pixel position in the horizontal direction, are calculated based on the pixel value of the integer pixel position and pixel values of the fourth through sixth integer pixel positions every time the pixel value of the integer pixel position in the predetermined area is read out.

3. The method for calculating an image difference according to claim 1, wherein differences of the plurality of the half pixel positions that are placed around the integer pixel position are calculated every time the pixel value of the integer pixel position in the predetermined area is read out.

4. The method for calculating an image difference according to claim 1, wherein the predetermined area is a block that is obtained by dividing a macro-block in quarters and has 8 pixels respectively aligning in both the vertical direction and the horizontal direction, the macro-block has 16 pixels respectively aligning in both the vertical direction and the horizontal direction, and the difference between the present image and the reference image is calculated by the block and the difference is calculated by the macro-block by using the difference obtained by the block.

5. The method for calculating an image difference according to claim 4, wherein if two blocks aligning in the horizontal direction out of four blocks obtained by dividing the macro-block in quarters are respectively a first block and a second block, a pixel value of a first half pixel position that is shared by the first block and the second block is calculated in only one of the first block and the second block.

6. The method for calculating an image difference according to claim 4, wherein if two blocks aligning in the vertical direction out of the four blocks obtained by dividing the macro-block in quarters are respectively the first block and a third block, a pixel value of a second half pixel position that is shared by the first block and the third block is calculated in only one of the first block and the third block.

7. An image difference operation device for calculating a difference between a present image and a reference image that is older than the present image by each predetermined area, comprising:
a half pixel position operation part calculating a pixel value of a half pixel position in the reference image by using a pixel value of an integer pixel position in the reference image read out from a memory; and
a difference operation part calculating a difference between the pixel value of the half pixel position obtained by the half pixel position operation part and a pixel value of a integer pixel position corresponding to the half pixel position in the present image, wherein the half pixel position operation part reads out the pixel value of the integer pixel position from the memory in a vertical direction of the reference image while the half pixel position operation part sequentially reads out the pixel value in order of the integer pixel position that aligns in a horizontal direction of the reference image starting from a first integer pixel position placed in an outer side of the predetermined area in the reference image, and the half pixel position operation part calculates pixel values of a plurality of half pixel positions, which are specified by the integer pixel position and a second integer pixel position that is adjacent to the integer pixel position and read out before the integer pixel position, based on the pixel value of the integer pixel position and a pixel value of the second integer pixel position every time the pixel value of the integer pixel position in the predetermined area is read out.

8. The image difference operation device for calculating an image difference according to claim 7, wherein the half pixel position operation part calculates the pixel values of the plurality of the half pixel positions, which are specified by the integer pixel position, a fourth integer pixel position adjacent to the integer pixel position in the horizontal direction, a fifth integer pixel position adjacent to the integer pixel position in the vertical direction and a sixth integer pixel position adjacent to the fourth integer pixel position in the vertical direction and adjacent to the fifth integer pixel position in the horizontal direction, based on the pixel value of the integer pixel position and pixel values of the fourth through sixth integer pixel positions every time the pixel value of the integer pixel position in the predetermined area is read out.

9. The image difference operation device for calculating an image difference according to claim 7, wherein the half pixel position operation part calculates differences of the plurality of the half pixel positions that are placed around the integer pixel position every time the pixel value of the integer pixel position in the predetermined area is read out.

10. A motion estimation device comprising:
the image difference operation device according to claim 7; and
a motion vector generation part generating a motion vector between the present image and the reference image whose difference is calculated by the image difference operation device, and generating the motion vector at which the difference or a difference by the macro-block obtained by using the difference becomes a minimum.

11. An image data compression device, comprising:
the image difference operation device according to claim 7; and
a quantization part quantizing a difference generated by the image difference operation device.
